(19) United States
(12) Patent Application Publication
(10) Pub. No.: US 2014/0300572 A1
(43) Pub. Date: Oct. 9, 2014

(54) TOUCH DETERMINATION BY TOMOGRAPHIC RECONSTRUCTION

(71) Applicant: FlatFrog Laboratories AB, Lund (SE)

(72) Inventors: Nicklas Ohlsson, Bunkeflostrand (SE); Peter Juhlin, Lund (SE); Tomas Christiansson, Torna-Hallestad (SE)

(73) Assignee: FLATFROG LABORATORIES AB, Lund (SE)

(21) Appl. No.: 14/354,236

(22) PCT Filed: Oct. 24, 2012
(86) PCT No.: PCT/SE2012/051142

§ 371 Date: Apr. 25, 2014

Related U.S. Application Data
(60) Provisional application No. 61/522,024, filed on Aug. 10, 2011.

(30) Foreign Application Priority Data
Oct. 27, 2011 (SE) 1151000-5

(51) Int. Cl. G06F 3/042

(52) U.S. Cl. CPC G06F 3/042
USPC 345/173

(57) ABSTRACT

Objects touching a surface portion attenuate transmitted signals. A data processor processes an output signal from a detector coupled to the outcoupling points, to generate a set of data samples indicative of detected energy for the actual detection lines. The set of data samples is further processed to generate a set of matched samples indicative of estimated detected energy for fictitious detection lines that extend across the surface portion in parallel groups at a plurality of different angles. The individual spacing between the fictitious detection lines in each group and the individual difference in angle between said groups are selected such that the set of matched samples transforms to Fourier coefficients arranged as data points on a pseudo-polar grid in a Fourier domain. The set of matched samples is processed by tomographic reconstruction to generate a two-dimensional distribution of an interaction parameter within the surface portion.

### CROSS-REFERENCE TO RELATED APPLICATIONS

The present application claims the benefit of Swedish patent application No. 1151000-5, filed 27 Oct. 2011, and U.S. provisional application No. 61/552,024, filed 27 Oct. 2011, both of which are incorporated herein by reference.

### TECHNICAL FIELD

The present invention relates to touch-sensitive panels and data processing techniques in relation to such panels.

### BACKGROUND ART

To an increasing extent, touch-sensitive panels are being used for providing input data to computers, electronic measurement and test equipment, gaming devices, etc. The panel may be provided with a graphical user interface (GUI) for a user to interact with using e.g. a pointer, stylus or one or more fingers. The GUI may be fixed or dynamic. A fixed GUI may e.g. be in the form of printed matter placed over, under or inside the panel. A dynamic GUI can be provided by a display screen integrated with, or placed underneath, the panel or by an image being projected onto the panel by a projector.

There are numerous known techniques for providing touch sensitivity to the panel, e.g. by using cameras to capture light scattered off the point(s) of touch on the panel, or by incorporating resistive wire grids, capacitive sensors, strain gauges, etc into the panel.

US2004/0252091 discloses an alternative technique which is based on frustrated total internal reflection (FTIR). Light sheets are coupled into a panel to propagate inside the panel by total internal reflection. When an object comes into contact with a surface of the panel, two or more light sheets will be locally attenuated at the point of touch. Arrays of light sensors are located around the perimeter of the panel to detect the received light for each light sheet. A coarse tomographic reconstruction of the light field across the panel surface is then created by geometrically back-tracing and triangulating all attenuations observed in the received light. This is stated to result in data regarding the position and size of each contact area.

US2009/0153519 discloses a panel capable of conducting signals. A “tomograph” is positioned adjacent the panel with signal flow ports arrayed around the border of the panel at discrete locations. Signals (b) measured at the signal flow ports are tomographically processed to generate a two-dimensional representation (x) of the conductivity on the panel, whereby touching objects on the panel surface can be detected. The presented technique for tomographic reconstruction is based on a linear model of the tomographic system, Ax=b. The system matrix A is calculated at factory, and its pseudo inverse A⁻¹ is calculated using Truncated SVD algorithms and operated on the measured signals to yield the two-dimensional (2D) representation of the conductivity: x=A⁻¹b. The suggested method is both demanding in the term of processing and lacks suppression of high frequency components, possibly leading to much noise in the 2D representation.

US2009/0153519 also makes a general reference to Computer Tomography (CT). CT methods are well-known imaging methods which have been developed for medical purposes. CT methods employ digital geometry processing to reconstruct an image of the inside of an object based on a large series of projection measurements through the object. Various CT methods have been developed to enable efficient processing and/or precise image reconstruction, e.g. Filtered Back Projection, ART, SART, Fourier-based reconstruction, etc. The CT methods set specific requirements for the projection measurements, which might be difficult to fulfill in a touch system. However, it would be desirable to capitalize on existing CT methods for reconstructing a 2D distribution of an interaction parameter across a touch surface based on a set of projection measurements.

### SUMMARY

It is an objective of the invention to enable touch determination on a panel based on projection measurements by use of existing CT methods.

Another objective is to provide a technique that enables determination of touch-related data at sufficient precision to discriminate between a plurality of objects in simultaneous contact with a touch surface.

This and other objectives, which may appear from the description below, are at least partly achieved by means of a method of enabling touch determination, a computer program product, a device for enabling touch determination, and touch-sensitive apparatuses according to the independent claims, embodiments thereof being defined by the dependent claims.

A first aspect of the invention is a method of enabling touch determination based on an output signal from a touch-sensitive apparatus. The touch-sensitive apparatus comprises a panel configured to conduct signals from a plurality of peripheral incoupling points to a plurality of peripheral outcoupling points, thereby defining actual detection lines that extend across a surface portion of the panel between pairs of incoupling and outcoupling points, at least one signal generator coupled to the incoupling points to generate the signals, and at least one signal detector coupled to the outcoupling points to generate the output signal. The method of the first aspect comprises the steps of processing the output signal to generate a set of data samples, wherein the data samples are indicative of detected energy for at least a subset of the actual detection lines; processing the set of data samples to generate a set of matched samples, wherein the matched samples are indicative of estimated detected energy for fictitious detection lines that extend across the surface portion in parallel groups at a plurality of different angles, wherein the individual spacing between said fictitious detection lines in each group and the individual difference in angle between said groups are selected such that the set of matched samples transforms to Fourier coefficients arranged as data points on a pseudo-polar grid in a Fourier domain; and processing at least the set of matched samples by tomographic reconstruction to generate a two-dimensional distribution of an interaction parameter within at least part of the surface portion.

In this method, the fixed set of actual detection lines of the touch-sensitive apparatus is effectively converted into a set of fictitious detection lines that extend across the surface portion so as to match the requirements of certain CT algorithms, viz. algorithms that are designed for processing efficient and/or memory efficient and/or precise tomographic reconstruction of an interaction field based on data samples that transforms to Fourier coefficients arranged as data points on a pseudo-polar grid in the Fourier domain. There is a plethora of such algorithms, including so-called Linogram algorithms and pseudo-polar algorithms, which thus may be used for processing the set of matched samples to generate the interaction field, which in turn may be processed for identification of touch data, such as location, shape or extent of all objects in contact with the surface portion.

As used herein, “detection lines that extend across the surface portion in parallel groups at a plurality of different angles” designates a plurality of groups of detection lines, where each group consists of detection lines that extend in parallel (i.e. at a given angle) across the surface portion, and where the detection lines of each group have a different angle across the surface portion compared to the detection lines of the other groups.

In one embodiment, the step of processing the set of matched samples comprises: operating a one-dimensional Fourier transformation function on separate subsets of the matched samples, each subset corresponding to one of said parallel groups, so as to generate complex values for the data points on the pseudo-polar grid, and processing the complex values to generate the two-dimensional distribution. The step of processing of the complex values may comprise operating an inverse Fourier transformation algorithm on the complex values.

In one embodiment, the step of processing the output signal comprises: generating the data samples in a two-dimensional sample space, wherein each data sample is representative of an actual detection line and is defined by a signal value and two dimension values that define the location of the actual detection line on the surface portion. The dimension values may comprise a rotation angle of the detection line in the plane of the panel, and a distance of the detection line in the plane of the panel from a predetermined origin.

In one embodiment, the step of processing the set of data samples comprises: generating estimated signal values of the matched samples at predetermined locations in the two-dimensional sample space, wherein the predetermined locations correspond to the fictitious detection lines. The estimated signal values may be generated by interpolation based on the signal values of the data samples, and each estimated signal value may be generated by interpolation of the signal values of neighboring data samples in the two-dimensional sample space.

In one embodiment, the step of processing the set of data samples further comprises: obtaining a predetermined two-dimensional interpolation function with nodes corresponding to the set of data samples, and calculating the estimated signal values according to the interpolation function and based on the signal values of the data samples. The method may further comprise a step of receiving exclusion data identifying one or more data samples to be excluded, and the step of processing the data samples may comprise: identifying the node corresponding to each data sample to be excluded, re-designing the predetermined interpolation function without the thus-identified node, and calculating the estimated signal values according to the re-designed interpolation function and based on the signal values of the data samples in the nodes of the re-designed interpolation function.

In one embodiment, the step of generating estimated signal values comprises, for each matched sample: calculating a weighted contribution to the matched sample from each data sample in at least a subset of the data samples, and aggregating the weighted contributions, wherein each weighted contribution is calculated as a function of the signal value of the data sample and a distance in the sample space between the matched sample and the data sample.

In an alternative embodiment, the step of processing the set of data samples comprises: operating a two-dimensional Fourier transformation algorithm designed for irregularly sampled data on the set of data samples to generate first Fourier coefficients arranged in a Cartesian grid, and generating the estimated signal values by operating an inverse Fourier transformation algorithm on the first Fourier coefficients to generate the set of matched samples. A Cartesian grid or Cartesian coordinate system is well-known to the skilled person. It denotes a grid in which the grid cells are unit squares and the vertices are defined by integer values.

In one embodiment, the interaction parameter is representative of one of attenuation and transmission.

In one embodiment, the two-dimensional distribution comprises values of the interaction parameter arranged in a Cartesian grid on the surface portion.

In one embodiment, the pseudo-polar grid consists of concentrically aligned polygons, wherein each of the polygons is a convex polygon with pair-wise parallel line segments. Each of said polygons may consist of 4, 8 or 12 line segments, and/or all parallel line segments among the polygons may contain an equal number of equispaced data points.

In one embodiment, the signals comprise one of electrical energy, light, magnetic energy, sonic energy and vibration energy.

In one embodiment, the panel defines a touch surface and an opposite surface, said at least one signal generator is arranged to provide light inside the panel, such that the light propagates from the incoupling points by internal reflection between the touch surface and the opposite surface to the outcoupling points for detection by said at least one signal detector, and the touch-sensitive apparatus is configured such that the propagating light is locally attenuated by one or more objects touching the touch surface.

A second aspect of the invention is a computer program product comprising computer code which, when executed on a data-processing system, is adapted to carry out the method of the first aspect.

A third aspect of the invention is a device for enabling touch determination based on an output signal of a touch-sensitive apparatus. The touch-sensitive apparatus comprises a panel configured to conduct signals from a plurality of peripheral incoupling points to a plurality of peripheral outcoupling points, thereby defining actual detection lines that extend across a surface portion of the panel between pairs of incoupling and outcoupling points, means for generating the signals at the incoupling points, and means for generating the output signal based on detected signals at the outcoupling points. the device comprises: means for receiving the output signal; means for processing the output signal to generate a set of data samples, wherein the data samples are indicative of detected energy for at least a subset of the actual detection lines; means for processing the set of data samples to generate a set of matched samples, wherein the matched samples are indicative of estimated detected energy for fictitious detection lines that extend across the surface portion in parallel groups at a plurality of different angles, wherein the individual spacing between said fictitious detection lines in each group and the individual difference in angle between said groups are selected such that the set of matched samples transforms to Fourier coefficients arranged as data points on a pseudo-polar grid in a Fourier domain; and means for processing the set of matched samples by tomographic reconstruction to generate a two-dimensional distribution of an interaction parameter within at least part of the surface portion.

A fourth aspect of the invention is a touch-sensitive apparatus, comprising: a panel configured to conduct signals from a plurality of peripheral incoupling points to a plurality of peripheral outcoupling points, thereby defining actual detection lines that extend across a surface portion of the panel between pairs of incoupling and outcoupling points; means for generating the signals at the incoupling points; means for generating an output signal based on detected signals at the outcoupling points; and the device for enabling touch determination according to the third aspect.

A fifth aspect of the invention is a touch-sensitive apparatus, comprising: a panel configured to conduct signals from a plurality of peripheral incoupling points to a plurality of peripheral outcoupling points, thereby defining actual detection lines that extend across a surface portion of the panel between pairs of incoupling and outcoupling points; at least one signal generator coupled to the incoupling points to generate the signals; at least one signal detector coupled to the outcoupling points to generate an output signal; and a signal processor connected to receive the output signal and configured to: process the output signal to generate a set of data samples, wherein the data samples are indicative of detected energy for at least a subset of the actual detection lines, process the set of data samples to generate a set of matched samples, wherein the matched samples are indicative of estimated detected energy for fictitious detection lines that extend across the surface portion in parallel groups at a plurality of different angles, wherein the individual spacing between said fictitious detection lines in each group and the individual difference in angle between said groups are selected such that the set of matched samples transforms to Fourier coefficients arranged as data points on a pseudo-polar grid in a Fourier domain, and process the set of matched samples by tomographic reconstruction to generate a two-dimensional distribution of an interaction parameter within at least part of the surface portion.

Any one of the above-identified embodiments of the first aspect may be adapted and implemented as an embodiment of any one of the second to fifth aspects.

Still other objectives, features, aspects and advantages of the present invention will appear from the following detailed description, from the attached claims as well as from the drawings.

### BRIEF DESCRIPTION OF DRAWINGS

Embodiments of the invention will now be described in more detail with reference to the accompanying schematic drawings.

FIG. 1 is a plan view of a touch-sensitive apparatus.

FIGS. 2A-2B are side and top plan views of touch-sensitive systems operating by frustrated total internal reflection (FTIR).

FIG. 3 is a top plan view of a touch-sensitive apparatus with an interleaved arrangement of emitters and sensors.

FIG. 4A is a flow chart of a reconstruction method, and FIG. 4B is a block diagram of a device that implements the method of FIG. 4A.

FIG. 5 illustrates the underlying principle of the Projection-Slice Theorem.

FIG. 6 illustrates a measurement system used for conventional tomographic analysis.

FIG. 7A is a plot of sampling points obtained by the measurement system in FIG. 6 with uniform sampling, and FIG. 7B is a 2D representation in the Fourier domain of the sampling points in FIG. 7A.

FIG. 8A is plot of sampling points obtained by the measurement system in FIG. 6 with non-uniform sampling, and FIG. 8B is a 2D representation in the Fourier domain of the sampling points in FIG. 8A.

FIG. 9 is a 2D representation in the Fourier domain of data matched to an octagonal pseudo-polar grid.

FIG. 10 is a plot of sampling points defined by interleaved arrangement in FIG. 3.

FIG. 11 is a plot of updated sampling points generated based on the sampling points in FIG. 10.

FIG. 12 is a 2D representation in the Fourier domain of the updated sampling points in FIG. 11.

FIG. 13 is a reference image mapped to an interleaved arrangement.

FIG. 14A is a graph of a 2D interpolation function for an interleaved arrangement, FIG. 14B illustrates the generation of interpolation points using the interpolation function of FIG. 14A, and FIG. 14C is a reconstructed attenuation field.

FIGS. 15A-15D and FIGS. 16A-16B illustrate how the 2D interpolation function is updated when sampling points are removed from reconstruction.

FIG. 17 is a flowchart of a process for Fourier-based reconstruction.

### DETAILED DESCRIPTION OF EXAMPLE EMBODIMENTS

The present invention relates to techniques for enabling extraction of touch data for at least one object, and typically multiple objects, in contact with a touch surface of a touch-sensitive apparatus. The description starts out by presenting the underlying concept of such a touch-sensitive apparatus, especially an apparatus operating by frustrated total internal reflection (FTIR) of light. Then follows an example of an overall method for touch data extraction involving tomographic reconstruction. The description continues to generally explain and exemplify the theory of tomographic reconstruction. Finally, different inventive aspects of applying techniques for tomographic reconstruction for touch determination are further explained and exemplified.

Throughout the description, the same reference numerals are used to identify corresponding elements.

### 1. TOUCH-SENSITIVE APPARATUS

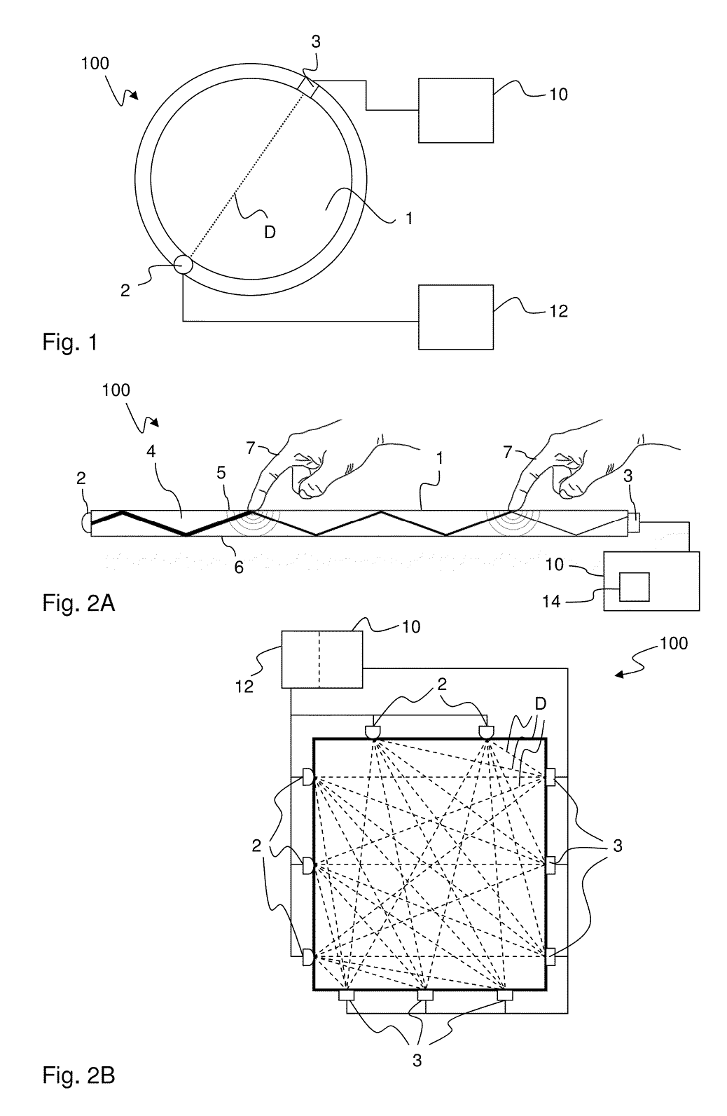

FIG. 1 illustrates a touch-sensitive apparatus 100 which is based on the concept of transmitting energy of some form across a touch surface 1, such that an object that is brought into close vicinity of, or in contact with, the touch surface 1 causes a local decrease in the transmitted energy. The touch-sensitive apparatus 100 includes an arrangement of emitters and sensors, which are distributed along the periphery of the touch surface. Each pair of an emitter and a sensor defines a detection line, which corresponds to the propagation path for an emitted signal from the emitter to the sensor. In FIG. 1, only one such detection line D is illustrated to extend from emitter 2 to sensor 3, although it should be understood that the arrangement typically defines a dense grid of intersecting detection lines, each corresponding to a signal being emitted by an emitter and detected by a sensor. Any object that touches the touch surface along the extent of the detection line D will thus decrease its energy, as measured by the sensor 3.

The arrangement of sensors is electrically connected to a signal processor 10, which samples and processes an output signal from the arrangement. The output signal is indicative of the received energy at each sensor 3. As will be explained below, the signal processor 10 may be configured to process the output signal by a tomographic technique to recreate a two-dimensional representation of the distribution of an interaction-related parameter (for simplicity, referred to as “interaction distribution” in the following) across the touch surface 1. The interaction distribution, which represents the local interaction with the signals that propagate across the touch surface, may be further processed by the signal processor 10 or by a separate device (not shown) for touch determination, which may involve extraction of touch data, such as a position (e.g. x, y coordinates), a shape or an area of each touching object.

In the example of FIG. 1, the touch-sensitive apparatus 100 also includes a controller 12 which is connected to selectively control the activation of the emitters 2 and, possibly, the readout of data from the sensors 3. The signal processor 10 and the controller 12 may be configured as separate units, or they may be incorporated in a single unit. One or both of the signal processor 10 and the controller 12 may be at least partially implemented by software executed by a processing unit 14.

The touch-sensitive apparatus 100 may be designed to be used with a display device or monitor, e.g. as described in the Background section. Generally, such a display device has a rectangular extent, and thus the touch-sensitive apparatus 100 (the touch surface 1) is also likely to be designed with a rectangular shape. Further, the emitters 2 and sensors 3 all have a fixed position around the perimeter of the touch surface 1. Thus, in contrast to a conventional tomographic apparatus used e.g. in the medical field, there will be no possibility of rotating the complete measurement system. As will be described in further detail below, this puts certain limitations on the use of standard tomographic techniques for recreating/reconstructing the interaction distribution within the touch surface 1.

In the embodiments shown herein, at least a subset of the emitters 2 may be arranged to emit energy in the shape of a beam or wave that diverges in the plane of the touch surface 1, and at least a subset of the sensors 3 may be arranged to receive energy over a wide range of angles (field of view). Alternatively or additionally, the individual emitter 2 may be configured to emit a set of separate beams that propagate to a number of sensors 3. In either embodiment, each emitter 2 transmits energy to a plurality of sensors 3, and each sensor 3 receives energy from a plurality of emitters 2.

The touch-sensitive apparatus 100 may be configured to permit transmission of energy in one of many different forms. The emitted signals may thus be any radiation or wave energy that can travel in and across the touch surface 1 including, without limitation, light waves in the visible or infrared or ultraviolet spectral regions, electrical energy, electromagnetic or magnetic energy, or sonic and ultrasonic energy or vibration energy.

In the following, an example embodiment based on propagation of light will be described. FIG. 2A is a side view of a touch-sensitive apparatus 100 which includes a light transmissive panel 4, one or more light emitters 2 (one shown) and one or more light sensors 3 (one shown). The panel 4 defines two opposite and generally parallel surfaces 5, 6 and may be planar or curved. A radiation propagation channel is provided between two boundary surfaces 5, 6 of the panel 4, wherein at least one of the boundary surfaces allows the propagating light to interact with a touching object 7. Typically, the light from the emitter(s) 2 propagates by total internal reflection (TIR) in the radiation propagation channel, and the sensors 3 are arranged at the periphery of the panel 4 to generate a respective measurement signal which is indicative of the energy of received light.

As shown in FIG. 2A, the light may be coupled into and out of the panel 4 directly via the edge portion that connects the top and bottom surfaces 5, 6 of the panel 4. Alternatively, not shown, a separate coupling element (e.g. in the shape of a wedge) may be attached to the edge portion or to the top or bottom surface 5, 6 of the panel 4 to couple the light into and/or out of the panel 4. When the object 7 is brought sufficiently close to the boundary surface, part of the light may be scattered by the object 7, part of the light may be absorbed by the object 7, and part of the light may continue to propagate in its original direction in the panel 4. Thus, when the object 7 touches a boundary surface of the panel (e.g. the top surface 5), the total internal reflection is frustrated and the energy of the transmitted light is decreased. This type of touch-sensitive apparatus is denoted “FTIR system” (FTIR—Frustrated Total Internal Reflection) in the following.

The touch-sensitive apparatus 100 may be operated to measure the energy (or, equivalently, power or intensity) of the light transmitted through the panel 4 on a plurality of detection lines. This may, e.g., be done by activating a set of spaced-apart emitters 2 to generate a corresponding number of light sheets inside the panel 4, and by operating a set of sensors 3 to measure the transmitted energy of each light sheet. Such an embodiment is illustrated in FIG. 2B, where each emitter 2 generates a beam of light that expands in the plane of the panel 4 while propagating away from the emitter 2. Each beam propagates from one or more entry or incoupling points on the panel 4. Arrays of light sensors 3 are located around the perimeter of the panel 4 to receive the light from the emitters 2 at a number of spaced-apart outcoupling points on the panel 4. It should be understood that the incoupling and outcoupling points merely refer to the position where the beam enters and leaves, respectively, the panel 4. Thus, one emitter/sensor may be optically coupled to a number of incoupling/outcoupling points. In the example of FIG. 2B, however, the detection lines D are defined by individual emitter-sensor pairs.

The light sensors 3 collectively provide an output signal, which is received and sampled by the signal processor 10. The output signal contains a number of sub-signals, also denoted “projection signals”, each representing the energy of light emitted by a certain light emitter 2 and received by a certain light sensor 3, i.e. the received energy on a certain detection line. Depending on implementation, the signal processor 10 may need to process the output signal for identification of the individual sub-signals. Irrespective of implementation, the signal processor 10 is able to obtain an ensemble of measurement values that contains information about the interaction distribution across the touch surface 1.

The light emitters 2 can be any type of device capable of emitting light in a desired wavelength range, for example a diode laser, a VCSEL (vertical-cavity surface-emitting laser), or alternatively an LED (light-emitting diode), an incandescent lamp, a halogen lamp, etc.

The light sensors 3 can be any type of device capable of detecting the energy of light emitted by the set of emitters, such as a photodetector, an optical detector, a photoresistor, a photovoltaic cell, a photodiode, a reverse-biased LED acting as photodiode, a charge-coupled device (CCD) etc.

The emitters 2 may be activated in sequence, such that the received energy is measured by the sensors 3 for each light sheet separately. Alternatively, all or a subset of the emitters 2 may be activated concurrently, e.g. by modulating the emitters 2 such that the light energy measured by the sensors 3 can be separated into the sub-signals by a corresponding de-modulation.

It is to be understood that FIG. 2 merely illustrates one example of an FTIR system. Further examples of FTIR systems are e.g. disclosed in U.S. Pat. No. 6,972,753, U.S. Pat. No. 7,432,893, US2006/0114237, US2007/0075648, WO2009/048365, WO2010/006882, WO2010/006883, WO2010/006884, WO2010/006885, WO2010/006886, and WO2010/064983, which are all incorporated herein by this reference. The inventive concept may be advantageously applied to such alternative FTIR systems as well.

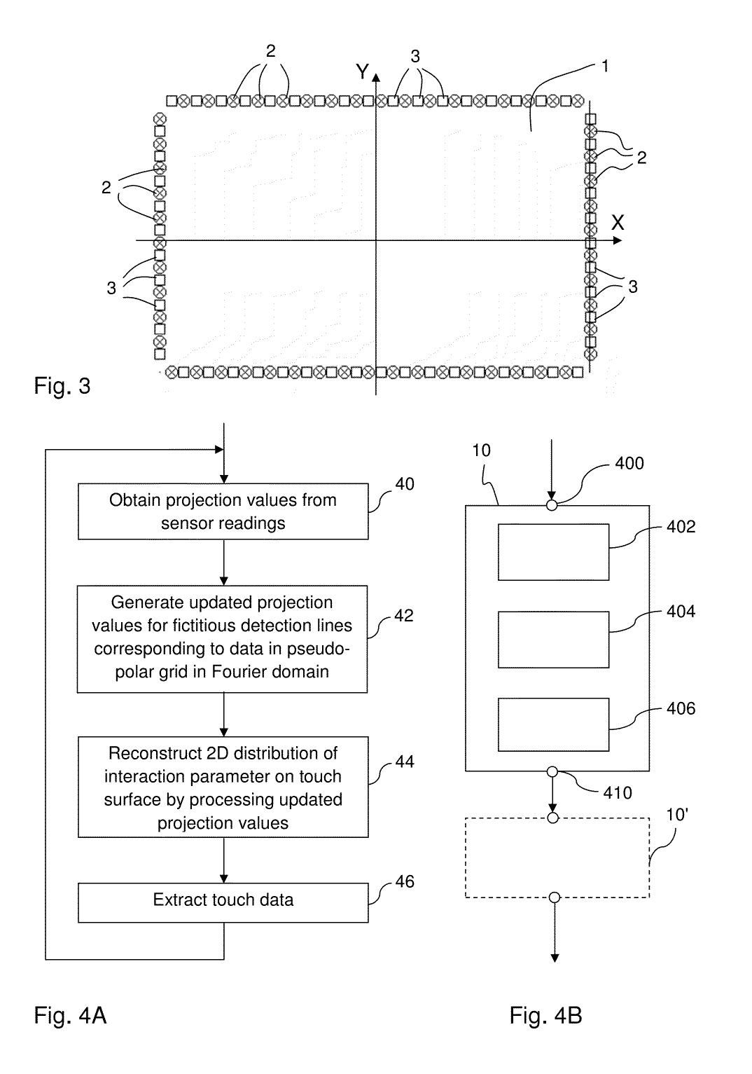

Below, embodiments of the invention will be described in relation to an “interleaved arrangement” of emitters 2 and sensors 3, shown in FIG. 3, in which the emitters 2 and sensors 3 are placed one after the other along the periphery of the touch surface 1. Thus, every emitter 2 is placed between two sensors 3. The distance between neighboring emitters 2 is the same along the periphery. The same applies for the distance between neighboring sensors 3. For example, the spacing between neighboring emitters 2 and sensors 3 may be from about 1 mm to about 20 mm. For practical as well as resolution purposes, the spacing may be in the 2-10 mm range. In a variant of the interleaved arrangement, the emitters 2 and sensors 3 may partially or wholly overlap, as seen in a plan view. This can be accomplished by placing the emitters 2 and sensors 3 on opposite sides of the panel 4, or in some equivalent optical arrangement.

All examples and illustrations are given for the sole purpose of illustration. It is thus to be understood that the concepts of the invention are applicable irrespective of aspect ratio, shape of the touch surface, and arrangement of emitters and sensors.

### 2. TRANSMISSION

As indicated in FIG. 2A, the light will not be blocked by the touching object 7. Thus, if two objects 7 happen to be placed after each other along a light path from an emitter 2 to a sensor 3, part of the light will interact with both objects 7. Provided that the light energy is sufficient, a remainder of the light will reach the sensor 3 and generate an output signal that allows both interactions (touch points) to be identified. Thus, in multi-touch FTIR systems, the transmitted light may carry information about a plurality of touches.

In the following, Tₖ is the transmission for the k:th detection line, Tᵥ is the transmission at a specific position along the detection line, and Aᵥ is the relative attenuation at the same point. The total transmission (modeled) along a detection line is thus:

$${T}_{k} = {\prod }_{v} {T}_{v} = {\prod }_{v} ( 1 - {A}_{v} )$$

The above equation is suitable for analyzing the attenuation caused by discrete objects on the touch surface, when the points are fairly large and separated by a distance. However, a more correct definition of attenuation through an attenuating medium may be used:

Iₖ=I_{0,k}·e^{-∫α(x(l))dl}→Tₖ=Iₖ/I_{0,k}=e^{-∫α(x(l))dl}

In this formulation, Iₖ represents the transmitted energy on the k:th detection line with attenuating object(s), I_{0,k} represents the transmitted energy on k:th detection line without attenuating objects, α(x)=α(x, y) is a two-dimensional attenuation coefficient field in the coordinate system of the touch surface (cf. XY in FIG. 3), and ∫α(x(l))dl is a line integral through the attenuation coefficient field.

To facilitate the tomographic reconstruction as described in the following, the measurement values may be divided by a respective background value. By proper choice of background values, the measurement values are thereby converted into transmission values Tₖ, which thus represent the fraction of the available light energy that has been measured on each of the detection lines.

The theory of the Radon transform (see below) deals with line integrals, and it may therefore be proper to operate on projection values sₖ given by the negative logarithm of the transmission:

sₖ=−log(Tₖ)=−log(e^{-∫α(x(l))dl})=∫α(x(l))dl

It can be noted that these projection values sₖ in fact are a measure of the total attenuation for the respective detection lines Dₖ.

In a variant, the projection values sₖ may be given by any known approximation to the above expression. A simple approximation of −log(Tₖ), which is a good approximation when Tₖ is close to 1 and may be useful also for smaller values of Tₖ, is given by sₖ=1−Tₖ.

### 3. RECONSTRUCTION AND TOUCH DATA EXTRACTION

FIG. 4A illustrates an embodiment of a method for reconstruction and touch data extraction in an FTIR system. The method involves a sequence of steps 40-46 that are repeatedly executed, typically by the signal processor 10 (FIGS. 1-2). In the context of this description, each sequence of steps 40-46 is denoted a sensing instance.

Each sensing instance starts by a data collection step 40, in which measurement values are sampled from the light sensors 3 in the FTIR system, typically by sampling a value from each of the aforesaid sub-signals. It may be noted that the data may, but need not, be collected for all available detection lines in the FTIR system. The data collection step 40 may also include pre-processing of the measurement values, e.g. filtering for noise reduction, conversion of measurement values into other formats, such as the above-mentioned transmission values or logarithmic transmission values (attenuation coefficient values), etc. It should be noted that further formats of the projection values are conceivable, such as energy, differential energy (e.g. given by a measured energy value subtracted by a background energy value for each detection line), and logarithmic energy. The data collection step 40 results in one projection value for each detection line.

In a re-calculation step 42, the set of projection values are processed for generation of an updated set of projection values that represent fictitious detection lines with predefined locations on the touch surface. This step typically involves an interpolation among the projection values as located in a 2D sample space which is defined by two dimensions that represent the unique location of the detection lines on the touch surface. In this context, a “location” refers to the extent of the detection line on the touch surface as seen in a plan view. It is to be noted that the updated set of projection values may contain part of the original projection values, which thus represent actual detection lines. As will be further explained and motivated in Chapter 4, the predefined locations are chosen such that the updated set of projection values transforms to Fourier coefficients arranged as data points on a pseudo-polar grid in the Fourier domain.

It should be noted that even if the data collection step 40 generates the projection values as logarithmic energy, log(Iₖ), the re-calculation step 42 may still be configured to produce the updated set of projection values in the format sₘ=−log(Tₘ), if desired, since sₘ=−log(Tₘ)=log(I_{0,m})−log(Iₘ). Here, index m denotes the individual fictitious detection lines. Thus, re-calculation step 42 may operate on projection values in format log(Iₖ) to generate an updated set of projection values in format log(Iₘ) and subtract them from an updated set of background values in format log(I_{0,m}). The updated set of background values in format log(I_{0,m}) have been computed by operating the re-calculation step 42 on the logarithmic background values, log(I_{0,k}), for the actual detection lines.

Generally, the background value I_{0,k} for a detection line may represent the transmitted energy without attenuating objects on the touch surface, or the transmitted energy obtained in the data collection step 40 in a preceding sensing instance, e.g. the immediately preceding sensing instance. The selection of background values are further discussed in Applicant's PCT applications No. PCT/SE2012/051006 filed on Sep. 24, 2012 and No. PCT/SE2012/051073 filed on Oct. 8, 2012, which are both incorporated herein by reference.

In a reconstruction step 44, the interaction distribution across the touch surface is reconstructed by processing the updated set of projection values by a tomographic reconstruction algorithm. The interaction distribution is a two-dimensional distribution of values of an interaction parameter. The format of the interaction parameter is given by the format of the updated set of projection values. Thus, the interaction parameter may be given as an absolute measure, such as energy, logarithmic energy or differential energy, or a relative measure, such as attenuation (e.g. the above-mentioned attenuation coefficient) or transmission. Step 44 may, e.g., operate a one-dimensional Fourier transformation function on the projection values for each separate group of parallel fictitious detection lines, so as to generate a complex value (representing amplitude and phase information) for each data point on the above-mentioned pseudo-polar grid, and then process the complex values in the pseudo-polar grid for generation of the interaction distribution, e.g. the above-mentioned attenuation coefficient field. The interaction distribution may be reconstructed within the entire touch surface or within one or more subareas of the touch surface.

In a subsequent extraction step 46, the interaction distribution is processed for identification of touch-related features and extraction of touch data. Any known technique may be used for isolating true (actual) touch points within the interaction distribution. For example, ordinary blob detection and tracking techniques may be used for finding the actual touch points. In one embodiment, a threshold is first applied to the interaction distribution, to remove noise. Any areas with interaction parameter values that exceed the threshold, may be further processed to find the center and shape by fitting for instance a two-dimensional second-order polynomial or a Gaussian bell shape to the attenuation values, or by finding the ellipse of inertia of the interaction parameter values. There are also numerous other techniques as is well known in the art, such as clustering algorithms, edge detection algorithms, standard blob detection, water shedding techniques, flood fill techniques, etc.

Any available touch data may be extracted, including but not limited to x,y coordinates, areas, shapes and/or pressure of the touch points.

After step 46, the extracted touch data is output, and the process returns to the data collection step 40.

It is to be understood that one or more of steps 40-46 may be effected concurrently. For example, the data collection step 40 of a subsequent sensing instance may be initiated concurrently with any of steps 42-46.

The touch data extraction process is typically executed by a data processing device (cf. signal processor 10 in FIGS. 1-2) which is connected to sample the measurement values from the light sensors 3 in the FTIR system. FIG. 4B shows an example of such a data processing device 10 for executing the process in FIG. 4A. In the illustrated example, the device 10 includes an input 400 for receiving the output signal. The device 10 further includes a data collection element (or means) 402 for processing the output signal to generate the above-mentioned set of projection values, and a re-calculation element (or means) 404 for generating the above-mentioned updated set of projection values. The device 10 further includes a reconstruction element (or means) 406 for generating the reconstructed interaction distribution by processing the updated set of projection values, and an output 410 for outputting the reconstructed interaction distribution. In the example of FIG. 4B, the actual extraction of touch data is carried out by a separate device 10′ which is connected to receive the interaction distribution from the data processing device 10.

The data processing device 10 may be implemented by special-purpose software (or firmware) run on one or more general-purpose or special-purpose computing devices. In this context, it is to be understood that each “element” or “means” of such a computing device refers to a conceptual equivalent of a method step; there is not always a one-to-one correspondence between elements/means and particular pieces of hardware or software routines. One piece of hardware sometimes comprises different means/elements. For example, a processing unit (cf. 14 in FIG. 2A) serves as one element/means when executing one instruction, but serves as another element/means when executing another instruction. In addition, one element/means may be implemented by one instruction in some cases, but by a plurality of instructions in some other cases. Such a software controlled computing device may include one or more processing units, e.g. a CPU (“Central Processing Unit”), a DSP (“Digital Signal Processor”), an ASIC (“Application-Specific Integrated Circuit”), discrete analog and/or digital components, or some other programmable logical device, such as an FPGA (“Field Programmable Gate Array”). The data processing device 10 may further include a system memory and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The special-purpose software may be stored in the system memory, or on other removable/non-removable volatile/non-volatile computer storage media which is included in or accessible to the data processing device 10, such as magnetic media, optical media, flash memory cards, digital tape, solid state RAM, solid state ROM, etc. The data processing device 10 may include one or more communication interfaces, such as a serial interface, a parallel interface, a USB interface, a wireless interface, a network adapter, etc, as well as one or more data acquisition devices, such as an A/D converter. The special-purpose software may be provided to the data processing device 10 on any suitable computer-readable medium, including a record medium and a read-only memory.

### 4. TOMOGRAPHIC TECHNIQUES

Tomographic reconstruction, which is well-known per se, may be based on the mathematics describing the Radon transform and its inverse. The following theoretical discussion is limited to the 2D Radon transform. The general concept of tomography is to do imaging of a medium by measuring line integrals through the medium for a large set of angles and positions. The line integrals are measured through the image plane. To find the inverse, i.e. the original image, many algorithms use the so-called Projection-Slice Theorem.

Several efficient algorithms have been developed for tomographic reconstruction, e.g. Filtered Back Projection (FBP), Fourier-based algorithms, ART (Algebraic Reconstruction Technique), SART (Simultaneous Algebraic Reconstruction Technique), etc. Fourier-based algorithms are widely used, and there are many implementations, variants and extensions thereof. Below follows a brief outline of the underlying mathematics for Fourier-based algorithms based on the Projection-Slice Theorem, for the sole purpose of facilitating the following discussion about the inventive concept and its merits.

### 4.1 Projection-Slice Theorem

Many tomographic reconstruction techniques make use of the mathematical theorem called Projection-Slice Theorem. This Theorem states that given a two-dimensional function ƒ(x, y), the one- and two-dimensional Fourier transforms [symbol] and [symbol] , a projection operator [symbol] that projects a two-dimensional (2D) function onto a one-dimensional (1D) line, and a slice operator S₁ that extracts a central slice of a function, the following calculations are equal:

[symbol]

[symbol]

ƒ(x,y)=S₁ [symbol] ƒ(x,y)

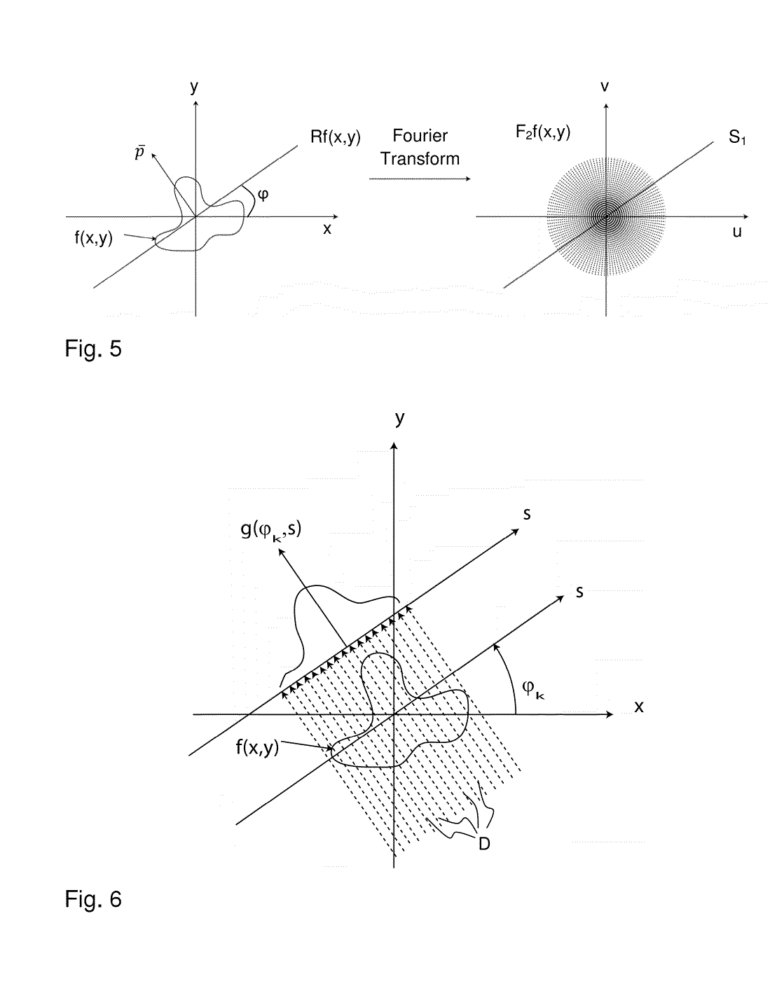

This relation is illustrated in FIG. 5. The right-hand side of the equation above essentially extracts a 1D line (a slice) of the 2D Fourier transform of the function ƒ(x, y). The line passes through the origin of the Fourier domain, as shown in the right-hand part of FIG. 5. The left-hand side of the equation starts by projecting (i.e. integrating along 1D lines in the projection direction p̅) the 2D function onto a 1D line (orthogonal to the projection direction p̅), which forms a “projection” that is made up of the projection values for all the different detection lines extending in the projection direction p̅. Thus, taking a 1D Fourier transform of the projection gives the same result as taking a slice from the 2D Fourier transform of the function ƒ(x, y). In the context of the following disclosure, the function ƒ(x, y) corresponds to the above-mentioned attenuation coefficient field α(x, y) (also denoted “attenuation field”) to be reconstructed.

### 4.2 Radon Transform

First, it may be noted that the attenuation vanishes outside the touch surface. For the following mathematical discussion, we define a circular disc that circumscribes the touch surface, Ω_{T}={x: |x|≦r}, with the attenuation field set to zero outside of this disc. Further, the projection value for a given detection line is given by:

$$g ( ϕ , s ) = ( ℛ f ) ( ϕ , s ) = {\int }_{s = ( x , y ) \cdot ( co s ϕ , s i n ϕ )} f ( x , y ) d l$$

If we define θ=(cos φ, sin φ) as a unit vector denoting the direction normal to the detection line, and s is the shortest distance (with sign) from the detection line to the origin (taken as the centre of the screen, cf. FIG. 5), the detection line may be may be parameterized as:

$$\{ \begin{matrix}x ( l ) = l \cdot sin ( ϕ ) + s \cdot cos ( ϕ ) \\ y ( l ) = - l \cdot cos ( ϕ ) + s \cdot sin ( ϕ )\end{matrix} .$$

We let the angle span the range 0≦φ<π, and since the attenuation field has support in Ω_{T}, it is sufficient to consider s in the interval −r≦s≦r. The set of projection values collected for different angles and distances may be stacked together to form a “sinogram”. The sinogram is generally given in a 2D sample space defined by dimensions that uniquely assign each projection value to a specific detection line. For example, the sample space may be defined by the above-mentioned angle and distance parameters φ, s.

The goal is now to retrieve information about ƒ(x, y) given the measured Radon transform, g= [symbol] f. The Radon transform operator is not invertible in the general sense. To be able to find a stable inverse, it may be necessary to impose restrictions on the variations of the attenuation field, e.g. bandwidth constraint.

One should note that the Radon transform is the same as the above-mentioned projection operator in the Projection-Slice Theorem. Hence, taking the 1D Fourier transform of g(φ, s) with respect to the s parameter results in central slices from the 2D Fourier transform of the attenuation field φ(x, y).

### 4.3 Fourier-Based Reconstruction Using the Projection-Slice Theorem

In tomographic processing, the mathematical reconstruction algorithms presume a specific geometric arrangement of the detection lines. In conventional tomography, e.g. as used in the field of medical imaging, the measurement system (i.e. the location of the incoupling points and/or outcoupling points) is controlled or set to yield the desired geometric arrangement of detection lines. Such a measurement system is exemplified in FIG. 6. Here, the system measures projection values of a set of detection lines for a given angle φₖ. In FIG. 6, the set of detection lines D are indicated by dashed arrows, and the resulting projection is represented by the function g(φₖ, s). The measurement system is then rotated slightly around the origin of the x,y coordinate system in FIG. 6, to collect projection values for a new set of detection lines at this new rotation angle. As shown by the dashed arrows, all detection lines are parallel to each other for each rotation angle.

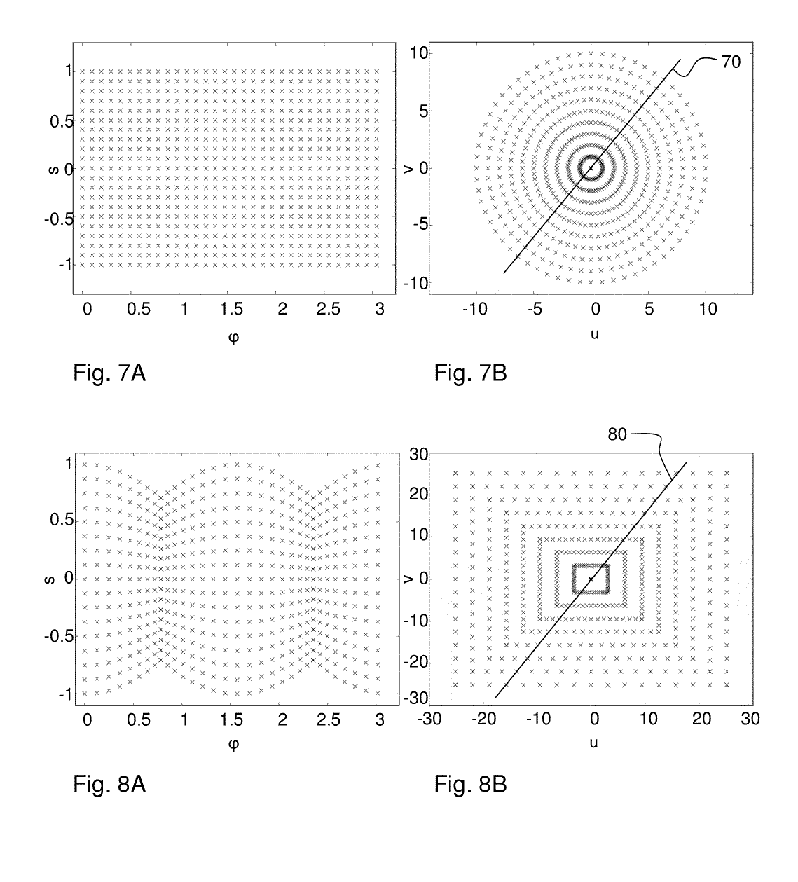

To further exemplify the reconstruction processing, consider a geometric arrangement in which the projection values are sampled with equal spacing in the angle and distance parameters φ, s, resulting in a sinogram as shown in FIG. 7A. The sinogram thus represents the function g(φ, s), and every cross in FIG. 7A corresponds to a detection line and is associated with a measured projection value.

The Projection-Slice Theorem states that taking a 1D Fourier transform of a projection, i.e. for a given value of the φ parameter, gives the same result as taking a slice from the 2D Fourier transform of the function ƒ(x, y). This means that the 1D Fourier transform of each column in the sinogram of FIG. 7A results in a slice of data points in the Fourier domain. Theoretically, the 2D Fourier transform of ƒ(x, y) is given by:

$$F ( u , v ) = {\int }_{- ∞}^{∞} {\int }_{- ∞}^{∞} f ( x , y ) \cdot {e}^{- 2 π \cdot i \cdot ( x \cdot u + y \cdot v )} d x d y$$

where u and v are dimension parameters that represent frequency in the x direction and y direction, respectively. Since ƒ(x, y) is represented by discrete data samples, F(u, v) is rather given by a corresponding discrete 2D Fourier transform, as is well-known to the person skilled in the art.

Each data point in such a slice of data points has a location given by specific frequency values of the dimension parameters u, v and is associated with a complex value corresponding to the Fourier coefficient of this specific location. All of the slices extend through the origin of the Fourier domain and the number of data points (outside the origin) on each slice is equal to the number of sampling points (projection values) in the respective column of the sinogram. FIG. 7B is a plot of the data points generated by discrete 1D Fourier transforms of the columns in FIG. 7A, with one slice being indicated by solid line 70. It should be noted that each data point in FIG. 7B is associated with a complex value indicative of amplitude and phase. According to the Projection-Slice Theorem, the frequency data in FIG. 7B represents the 2D Fourier transform F(u, v) of the function ƒ(x, y). As seen in FIG. 7B, the frequency data F(u, v) obtained from the data samples in the sinogram of FIG. 7A matches a polar grid in the Fourier domain (Fourier space), i.e. the data points in F(u, v) are arranged in concentric circles around the origin, and each circle contains the same number of equiangularly spaced data points.

It is realized that the function ƒ(x, y) may be reconstructed by applying a Fourier inversion process to the frequency data F(u, v), e.g. an inverse 2D FFT. More information on different types of Fourier inversion processes are found, e.g., in “The Mathematics of Computerized Tomography” by Natterer, and “Principles of Computerized Tomographic Imaging” by Kak and Slaney.

The Fourier inversion process needs to convert the polar distribution of discrete data points in F(u, v) into a Cartesian distribution of data samples in the function ƒ(x, y). Such a Fourier inversion process may require an interpolation among the data points in F(u, v). It has been found difficult to design such an algorithm which is sufficiently computationally fast and stable for practical purposes.

Therefore, alternative Fourier-based reconstruction techniques have been designed to obviate the need for interpolation among the data points in F (u, v).

One such technique is known as the Linogram algorithm, which does not require interpolation in the Fourier domain, but rather assumes that the projection values g(φ, s) are sampled in such a way that the discrete 1D Fourier transform provides frequency data in the Fourier domain on a grid that makes it possible to use an FFT algorithm denoted the chirp-z algorithm to reconstruct the function ƒ(x, y). More information about the Linogram algorithm may be found, e.g., on pages 106-108 in the book “Mathematical Methods in Image Reconstruction”, 2001, by Frank Natterer and Frank Wübbeling, the article “Linograms in Image Reconstruction from Projections”, IEEE Trans. Med. Imaging, vol. MI-6, pages 301-307 (1987), by Paul Edholm and Gabor T. Herman, and the article “Image Reconstruction from Linograms: Implementation and Evaluation”, IEEE Trans. Med. Imaging, vol 7, no 3, pages 239-246 (1988), by Paul Edholm, Gabor T. Herman and David A. Roberts, all of which are incorporated herein by reference.

The theory behind the Linogram algorithm requires the sinogram g(φ, s) to be sampled according to:

$$\begin{matrix}\{ \begin{matrix}{ϕ}_{μ} = {tan}^{- 1} ( \frac{μ}{p} ) & μ = - p , … , p \\ {s}_{μ , l} = \frac{r \cdot cos ( {ϕ}_{μ} )}{q} \cdot l & l = - q , … , q\end{matrix} & ( 1 ) \\ \{ \begin{matrix}\overline{{ϕ}_{μ}} = {cot}^{- 1} ( \frac{μ}{p} ) & μ = - p , … , p \\ \overline{{s}_{μ , l}} = \frac{r \cdot sin ( \overline{{ϕ}_{μ}} )}{q} \cdot l & l = - q , … , q\end{matrix} & ( 2 )\end{matrix}$$

where r is the radius of a circle circumscribing the function ƒ(x, y), 4·p is the number of projections and 2·q+1 is the number of data samples of each column in the sinogram. Such a sinogram, i.e. the data samples arranged in a (φ, s) plane, is denoted a “linogram”. The first set of equations (1) defines the sampling points for −π/4≦φ≦π/4 and the second set of equations (2) defines the sampling points for π/4≦φ≦3π/4. FIG. 8A is a plot of such a linogram, which thus indicates the different detection lines to be used by the measurement system for sampling the projection values.

Taking the 1D discrete Fourier transforms of the columns in the linogram yields frequency data F(u, v) in the Fourier domain according to:

$$\begin{matrix}u = \frac{ξ \cdot π}{r} \\ ξ = - p , … , p & ( 3 a ) \\ v = \frac{ξ \cdot π}{r} \cdot \frac{μ}{p} \\ ξ = - p , … , p & ( 3 b ) \\ u = \frac{ξ \cdot π}{r} \cdot \frac{μ}{p} \\ ξ = - p , … , p & ( 4 a ) \\ v = \frac{ξ \cdot π}{r} \\ ξ = - p , … , p & ( 4 b )\end{matrix}$$

This means that the data points are arranged on a grid of concentric rectangles centered on the origin in the Fourier domain. The rectangles may or may not have sides of equal length. FIG. 8B is a plot of the frequency data F(u, v) that corresponds to the linogram in FIG. 8A. As understood from the foregoing discussion in relation to FIG. 7, each column in the linogram of FIG. 8A results in a slice of data points through the origin in the Fourier domain of FIG. 8B, as exemplified by solid line 80. This means that each rectangle in FIG. 8B contains the same number of data points, which is twice the number of columns in the linogram. It also means that all parallel line segments of the rectangles contain the same number of data points. In this context, a “line segment” denotes a side of the rectangle. The data points are typically equispaced within each line segment, which means that the slices formed by the 1D Fourier transformations of columns in the linogram are non-angularly spaced in the Fourier domain. This type of grid is one implementation of a so-called “pseudo-polar grid”.

The Linogram algorithm presented by Edholm et al in the above-mentioned articles is based on the fact that it is possible to reconstruct ƒ(x, y) as the sum of two partial reconstructions ƒ(x, y)=ƒ_{T}(x, y)+ƒ_{C}(x, y), where ƒ_{T}(x, y) is obtained from the data points corresponding to the data samples in −π/4≦φ≦π/4, and ƒ_{C}(x, y) is obtained from the data points corresponding to the data samples in π/4≦φ≦3π/4. This means that the partial reconstructions are computed by 1D Fourier inversion processing of the data points that are arranged along vertical lines and horizontal lines, respectively, in the Fourier domain. The computation makes use of the chirp-z transform in both partial reconstructions.

It should be noted that the measurement system may be adapted to yield a linogram optimized for the use of FFT algorithms, e.g. by choosing the number of projections and/or the number of data samples in each column of the linogram so as to match a requirement of FFT algorithms. Alternatively, such optimization may be achieved by zero-padding.

The above-described Linogram algorithm may be modified in many different ways. In one example, a 1D NER NUFFT algorithm is used for computing the 1D Fourier transform of the columns in the linogram, and a 1D NED NUFFT algorithm is used for reconstructing ƒ_{T}(x, y) and ƒ_{C}(x, y), respectively, instead of the chirp-z transform. NUFFT (Non-Uniform FFT) algorithms, which are well-known to the skilled person, are designed as an adaptation of a regular discrete Fourier transformation function, e.g. an FFT, to handle non-uniform input data and/or output data while retaining the “fast” property of the FFT algorithms, thus allowing for time complexities of O(n²·log(n)). A Non-Equispaced Result FFT (NER NUFFT) operates on equispaced input data to yield output data in non-equispaced locations, and a Non-Equispaced Data FFT (NED NUFFT) operates on non-equispaced input data to yield output data in equispaced locations. There are many different variants of NUFFT algorithms; some use least-squares, some use iterative solutions and some use Fourier expansion (Shannon's sampling theorem). There are also other types of Linogram algorithms.

There are also so-called pseudo-polar algorithms, which are likewise based on the concept of requiring sampling of the projection values g(φ, s) in such a way that corresponding frequency data is mapped to a pseudo-polar grid represented by concentric rectangles in the Fourier domain. The main major difference over the Linogram algorithm is that the pseudo-polar algorithm introduces zero-padding and over sampling, which may ensure pseudo-invertibility, whereas the Linogram algorithm in certain respects may violate Shannon's sampling theorem. Pseudo-polar reconstruction algorithms are, e.g., described in “Fast Slant Stack: A notion of Radon Transform for Data in a Cartesian Grid which is Rapidly Computible, Algebraically Exact, Geometrically Faithful and Invertible” (2001), by A. Averbuch, R.R. Coifman, D. L. Donoho, M. Israeli, J. Waldén, and “A new Nearly-Polar FFT and Analysis of Fourier-Radon Relations in Discrete Spaces”, by Ofir Harari, Master thesis, Ben-Gurion University of Negev (2007), all of which are incorporated herein by reference.

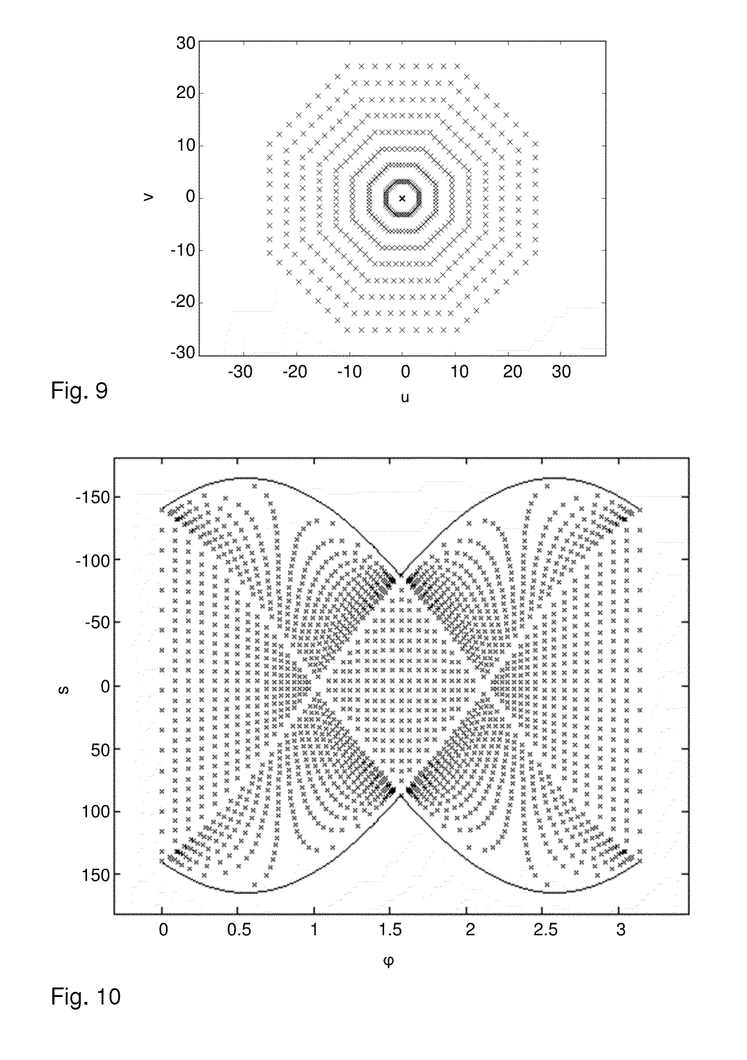

There are also Fourier-based reconstruction algorithms that use generalized pseudo-polar grids, e.g. in which the frequency data is matched to a N-sided convex polygon that consists of N/2 wedge pairs. A wedge pair is formed by opposing parallel line segments of the polygon. The polygon may or may not be a regular polygon, i.e. a polygon that is both equiangular and equilateral. Reverting to FIG. 8B, the grid consists of one wedge pair with horizontal line segments and one wedge pair with vertical line segments. FIG. 9 is a plot of frequency data matched to an octagonal grid, which consists of four wedge pairs. As the number of line segments (N) increases, the reconstructed function ƒ(x, y) improves in terms of accuracy and resolution, but the computational complexity will also be increased. Further details with respect to pseudo-polar grids with 4, 8 and 12-sided polygons are found in the article “Generalized pseudo-polar Fourier grids and applications in registering ophthalmic optical coherence tomography images”, by Chou et al, presented on 43rd Asilomar Conference on Signals, Systems and Computers, pages 807-811 (2009), which is incorporated herein by reference.

### 5. USE OF TOMOGRAPHIC PROCESSING FOR TOUCH DETERMINATION

FIG. 10 is a sinogram that illustrates the sampling points (corresponding to detection lines, and thus to measured projection values) in the φ-s-plane for the interleaved system shown in FIG. 3. As seen, the arrangement of sampling points is irregular, and it is realized that it is difficult to apply the Projection-Slice Theorem on this data set.

In FIG. 10, the solid lines indicate the physical limits of the touch surface. It can be noted that the angle φ actually spans the range from 0 to 2π, since the incoupling and outcoupling points extend around the entire perimeter. However, a detection line is the same when rotated by π, and the projection values can thus be rearranged to fall within the range of 0 to π. This rearrangement is optional; the data processing can be done in the full range of angles with a correction of some constants in the reconstruction function(s).

In contrast to ordinary tomographic applications, the measurement system is fixed and cannot be adapted to yield sampling points matched to the requirements of a specific reconstruction algorithm. This problem is overcome by the re-calculation step (42 in FIG. 4A), which processes the projection values of the sampling points for generation of projection values for an updated set of sampling points. The updated set of sampling points have such a location in the φ-s-plane that they match a pseudo-polar grid in the Fourier domain. The generation of projection values of the updated set of sampling points may be generated by interpolating the original sampling points.

The updated set of sampling points may be understood in relation to FIG. 6. As discussed in Chapter 4, the matching of data points to a pseudo-polar grid requires specific non-uniform sampling of data by the measurement system in FIG. 6. To mimic such a non-uniform sampling of data, the updated set of sampling points is generated to represent fictitious detection lines that extend across the touch surface in a plurality of groups with parallel detection lines, where the angle of the detection lines differ between the groups. Specifically, each group is defined to contain a given number of parallel fictitious detection lines with a dedicated individual spacing (equal to an intra-column spacing, Δs), and the different groups are shifted by a dedicated individual angle to each other (equal to an inter-column spacing, Δφ). The inter-column and intra-column distances in the updated set of sampling points is selected such that it transforms to Fourier coefficients arranged as data points on a pseudo-polar grid in the Fourier domain, e.g. in accordance with the requirements set by the Linogram algorithms or the (generalized) pseudo-polar algorithms discussed in Chapter 4.

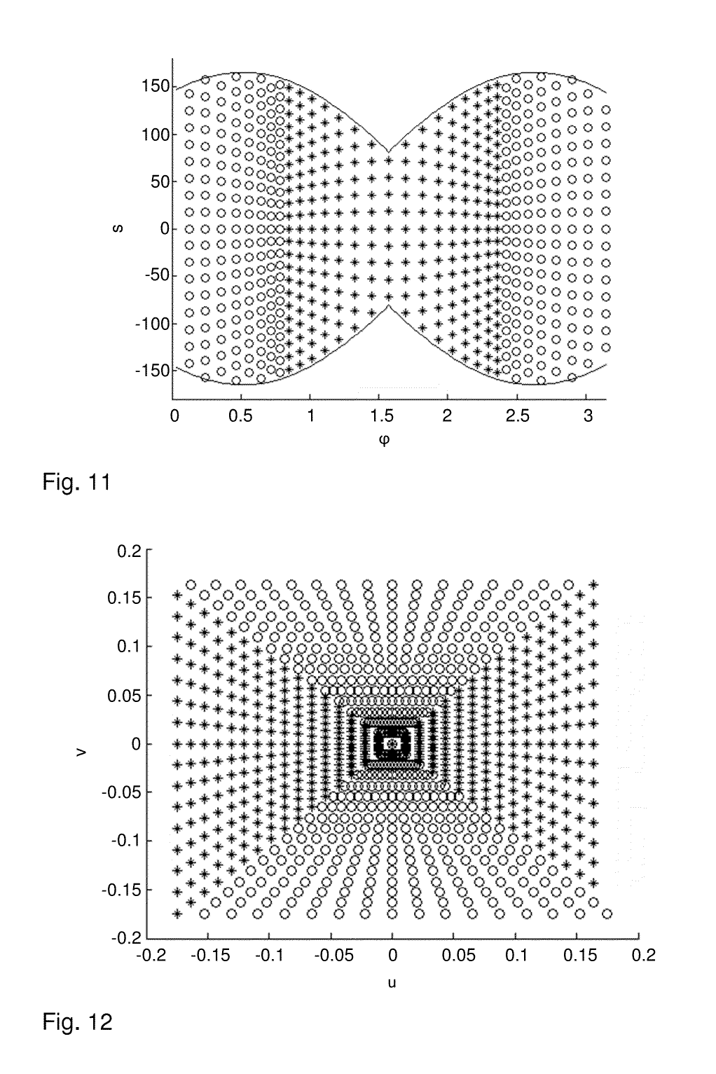

An example of an updated set of sampling points for the interleaved system in FIG. 3 is shown in FIG. 11, which is obtained by interpolating the sampling points in FIG. 10. The updated set of sampling points corresponds to data points in a 4-sided pseudo-polar grid in the Fourier domain, as shown in FIG. 12. The data points are thus arranged on concentric rectangles in the Fourier domain. FIGS. 11-12 also indicate that the data samples of columns in π/4≦φ≦3π/4 (indicated by stars) result in data points in vertical line segments in the Fourier domain, and that the data samples of columns in 0≦φ≦π/4 and 3π/4≦φ≦π (indicated by circles) result in data points in horizontal line segments in the Fourier domain. As understood from the foregoing discussion in Chapter 4, there is a multitude of available standard algorithms for reconstructing the attenuation field α(x, y) from the pseudo-polar data set in FIG. 12.

The objective of the interpolation is to find an interpolation function that can produce interpolated values at specific interpolation points in the sample space given a set of measured projection values at the original sampling points. The interpolation points, possibly together with part of the original sampling points, form the above-mentioned updated set of sampling points. Basically, the interpolation operates to arrange the sampling points in columns in the φ-s-plane, and to set the spacing of individual columns (Δφ), and the spacing of individual sampling points within each column (Δs) such that the 1D Fourier transformation of all columns results in data points that are arranged on a selected pseudo-polar grid in the Fourier domain.

Many different interpolating functions may be used for this purpose, i.e. to interpolate sampling points on a two-dimensional grid. Input to such an interpolation function is the original sampling points in the sample space as well as the measured projection value for each original sampling point. Most interpolating functions involve applying a linear operator on the measured projection values. The coefficients in the linear operator are given by the known locations of the original sampling points and the interpolation points in the sample space. The linear operator may be pre-computed and then applied on the measured projection values in each sensing instance (cf. iteration of steps 40-46 in FIG. 4A). Some non-limiting examples of suitable interpolation functions include Delaunay triangulation, and other types of interpolation using triangle grids, bicubic interpolation, e.g. using spline curves or Bezier surfaces, Sinc/Lanczos filtering, nearest-neighbor interpolation, and weighted average interpolation. Alternatively, the interpolation function may be based on Fourier transformation(s) of the measured projection values.

Below, the use of different interpolation functions in the re-calculation step (42 in FIG. 4A) will be further exemplified. Sections 5.1 and 5.2 exemplify the use of Delaunay triangulation, section 5.3 exemplifies the use of Fourier transformation techniques, and section 5.4 exemplifies the use of weighted average interpolation.

In the examples that are based on Delaunay triangulation, the sampling points are placed at the corners of a mesh of non-overlapping triangles. The values of the interpolation points are linearly interpolated in the triangles. The triangles can be computed using the well-known Delaunay algorithm. To achieve triangles with reduced skewness, the dimensions of the sample space (φ, s) may be re-scaled to essentially the same length, before the Delaunay triangulation algorithm is applied.

In all of the following examples, the interpolation function is able to produce output values for any given position in the sample space. However, the frequency information in the updated set of sampling points will be limited according to the density of original sampling points in the sample space. Thus, wherever the original density is high, the updated set of sampling points can mimic high frequencies present in the sampled data. Wherever the original density is low, as well as if there are large gaps in the sample space, the updated set will only be able to produce low frequency variations. Certain arrangements of emitters and sensors may produce a sample space with one or more contiguous regions (also denoted “gap regions”) that lack sampling points. These gap regions may be left as they are, or be populated by interpolation points.

The following examples will illustrate re-calculation of sampling points such that their Fourier domain representation matches a 4-sided pseudo-polar grid, as shown in FIG. 12.

### 5.1 Re-Calculation by Delaunay Interpolation

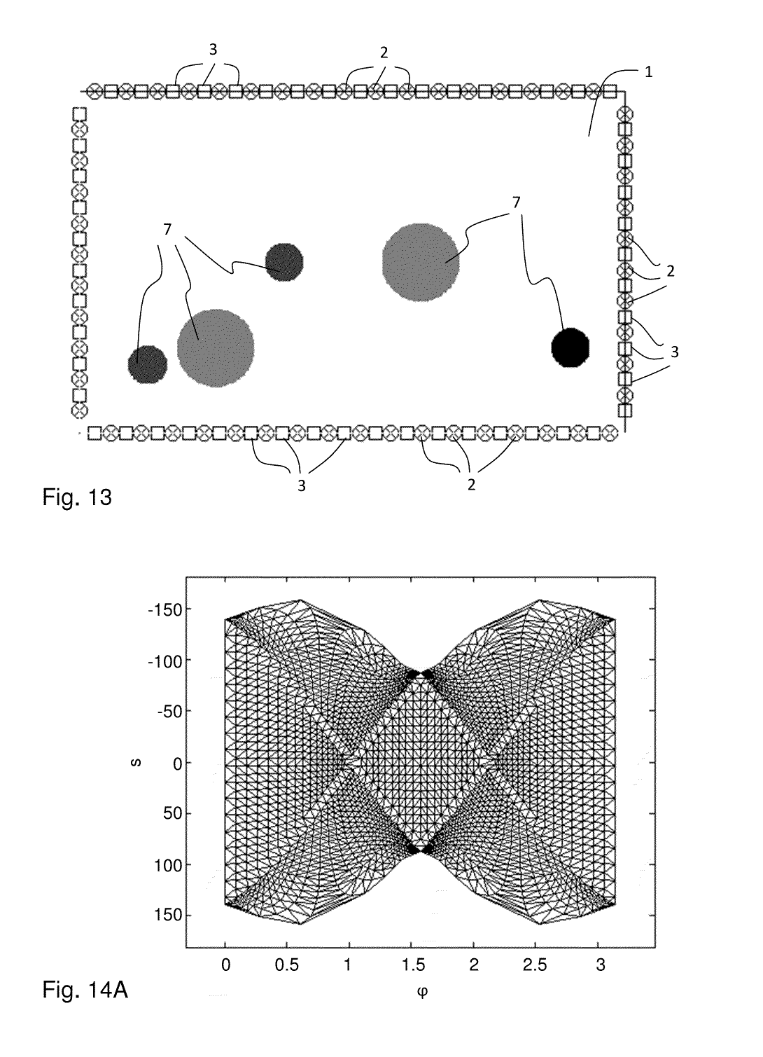

This example is given for the interleaved arrangement shown in FIG. 3, assuming the reference image shown in FIG. 13. The reference image is thus formed by five touching objects 7 of different size and attenuation strength that are distributed on the touch surface 1. For reasons of clarity, FIG. 13 also shows the emitters 2 and sensors 3 in relation to the reference image.

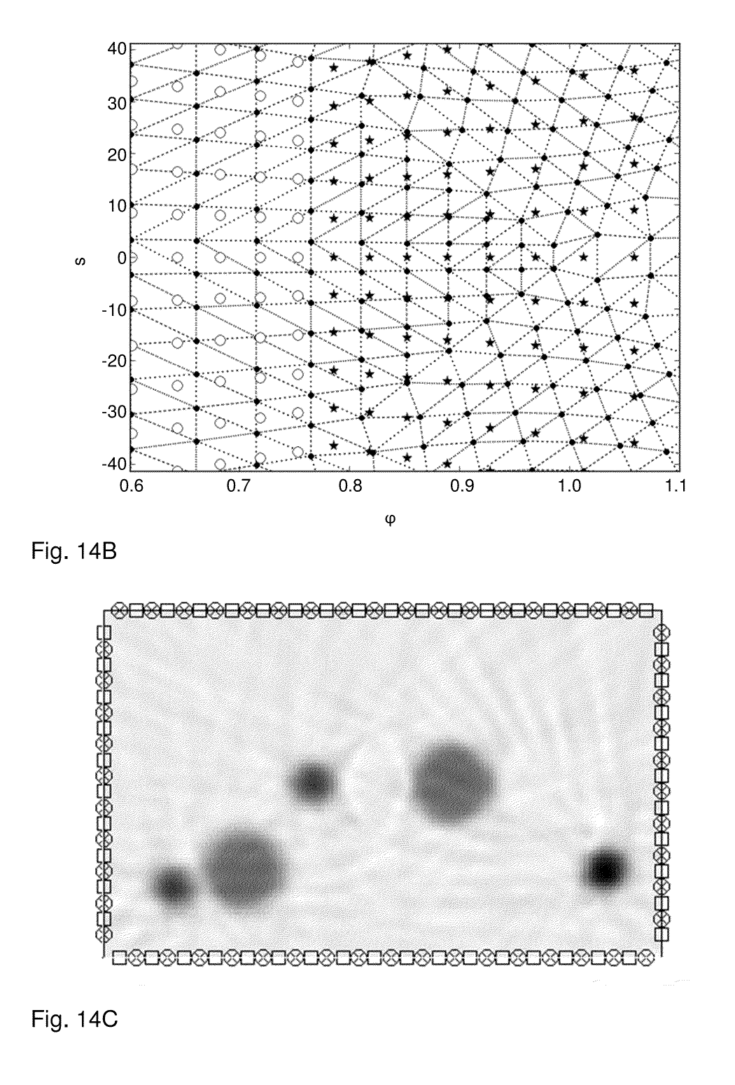

FIG. 14A is a plan view of the resulting sample space, where a mesh of non-overlapping triangles have been adapted to the sampling points so as to provide a two-dimensional interpolation function. FIG. 14B is a close-up of FIG. 14A to illustrate the sampling points (filled circles) and the Delaunay triangulation (dotted lines extending between the sampling points). FIG. 14B also illustrates the interpolation points (stars and open circles, respectively). Thus, the values of the interpolation points are calculated by operating the Delaunay triangulation on the projection values in the sampling points. In the illustrated example, the interpolation points replace the sampling points in the subsequent calculations. In other words, the sinogram formed by the measured projection values is replaced by an interpolated sinogram formed by interpolated projection values. Thereby, it is possible to obtain any desired inter-column and intra-column spacing. Each interpolation point corresponds to a fictitious detection line across the touch surface.

The interpolation points are arranged as columns (i.e. with respect to the s variable) in the sample space, as shown in FIG. 11, allowing subsequent 1D Fourier transformation with respect to the s variable, where the inter-column and intra-column spacing is selected to result in frequency data F(u, v) arranged in the 4-sided pseudo-polar grid, as shown in FIG. 12.

FIG. 14C illustrates the attenuation field that is obtained based on the pseudo-polar FFT, as described in the above-mentioned article of Averbuch et al, by applying an iterative approach for calculating the inverse of this pseudo-polar FFT, according to the article “Fast and accurate Polar Fourier transform”, Applied and Computational Harmonic Analysis, 21:145-167 (2006), by A. Averbuch, R. R. Coifman, D. L. Donoho, M. Elad, and M. Israeli, which is incorporated herein by reference. By comparing FIG. 14C with FIG. 13, it is realized that the reconstruction process is capable of adequately representing the location, size and shape of the touching objects in the attenuation field.

Variants for generating the updated set of sampling points are of course possible. For example, different interpolation techniques may be used concurrently on different parts of the sample space, or certain sampling points may be retained whereas others are replaced by interpolated points in the updated set of sampling points.

As will be explained in the following, the generation of the updated set of sampling points may be designed to allow detection lines to be removed dynamically during operation of the touch-sensitive apparatus. For example, if an emitter or a sensor starts to perform badly, or not at all, during operation of the apparatus, this may have a significant impact on the reconstructed attenuation field. It is conceivable to provide the apparatus with the ability of identifying faulty detection lines, e.g. by monitoring temporal changes in output signal of the light sensors, and specifically the individual projection signals. The temporal changes may e.g. show up as changes in the energy/attenuation/transmission or the signal-to-noise ratio (SNR) of the projection signals. Any faulty detection line may be removed from the reconstruction. Examples of techniques for identifying faulty detection lines are disclosed in WO2011/078769 and in Applicant's PCT application No. PCT/SE2012/050509, which was filed on May 14, 2012, which are both incorporated herein by reference. To fully benefit from such functionality, the touch-sensitive apparatus may be designed to have slightly more sensors and/or emitters than necessary to achieve adequate performance, such that it is possible to discard a significant amount of the projection values, for example 5%, without significantly affecting performance.

The re-calculation step (cf. step 42 in FIG. 4A) may be configured to dynamically (i.e. for each individual sensing instance) account for such faulty detection lines by, whenever a detection line is marked as faulty, removing the corresponding sampling point in the sample space and re-computing the interpolation function around that sampling point. Thereby, the density of sampling points is reduced locally (in the φ-s-plane), but the reconstruction process will continue to work adequately while discarding information from the faulty detection line.

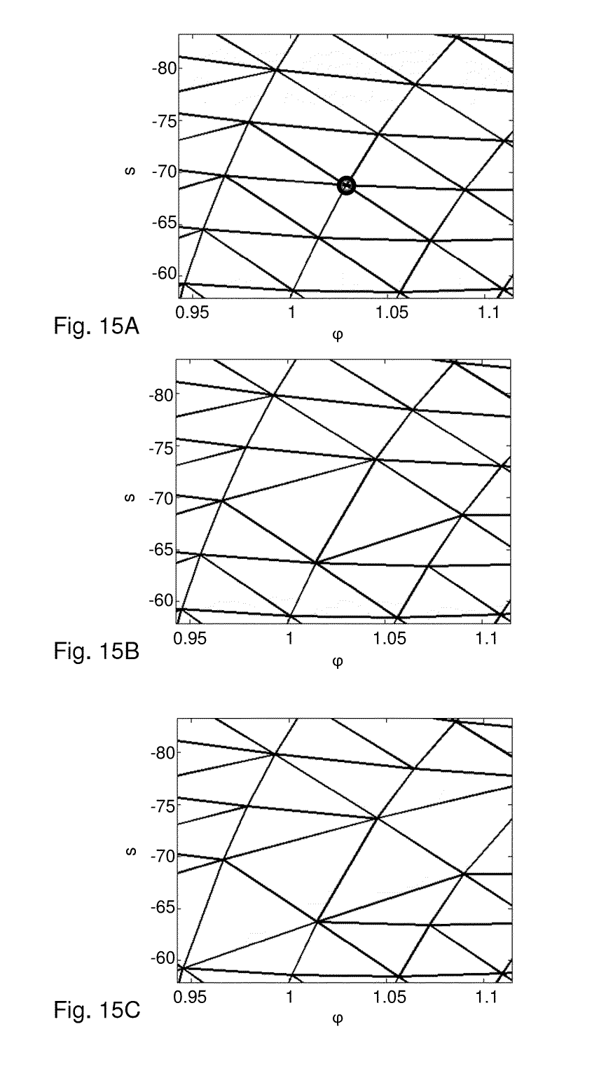

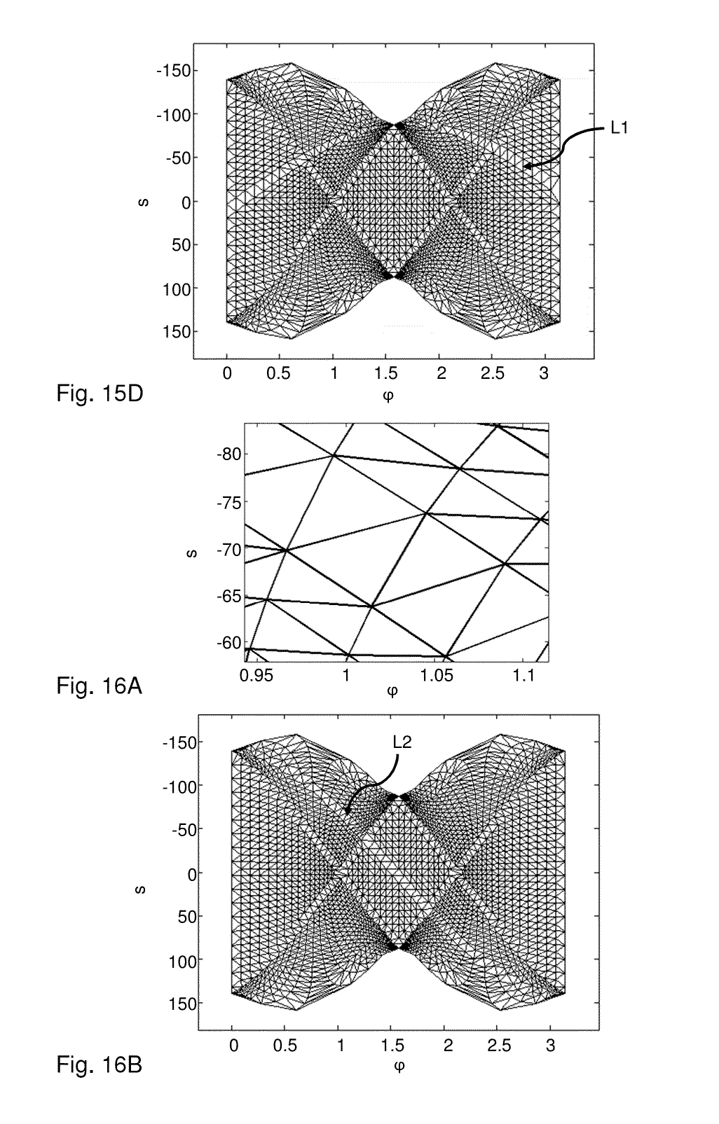

This is further illustrated in FIGS. 15-16. FIG. 15A is a close-up of two-dimensional interpolation function formed as an interpolation grid in the sample space. Assume that this interpolation function is stored for use in the re-calculation step for a complete set of sampling points. Also assume that the sampling point indicated by a circle in FIG. 15A corresponds to a detection line which is found to be faulty. In such a situation, the sampling point is removed, and the interpolation function is updated or recomputed based on the remaining sampling points. The result of this operation is shown in FIG. 15B. As shown, the change will be local to the triangles closest to the removed sampling point.

If an emitter is deemed faulty, all detection lines originating from this emitter should be removed. This corresponds to removal of a collection of sampling points and a corresponding update of the interpolation function. FIG. 15C illustrates the interpolation function in FIG. 15A after such updating, and FIG. 15D illustrates the updated interpolation function for the complete sample space. The removal of the detection lines results in a band of lower density (indicated by arrow L1), but the reconstruction process still works properly.

Instead, if a sensor is deemed faulty, all detection lines originating from this sensor should be removed. This is done in the same way as for the faulty emitter, and FIG. 16A illustrates the interpolation function in FIG. 15A after such updating. FIG. 16B illustrates the updated interpolation function for the complete sample space. The removal of the detection lines again results in a band of lower density (indicated by arrow L2), but the reconstruction process still works properly.

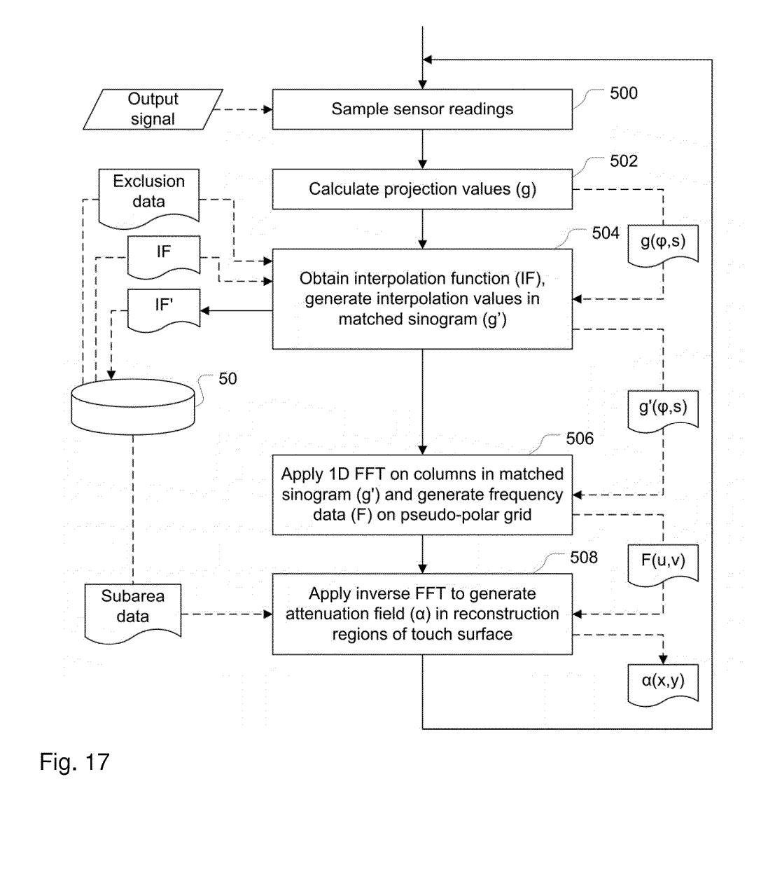

FIG. 17 is a flowchart of an exemplifying reconstruction process, which is a more detailed version of the general process in FIG. 4A adapted for data processing in a touch-sensitive apparatus with an interleaved arrangement. The process operates on the output signal from the light sensor arrangement, using data stored in a system memory 50, and intermediate data generated during the process. It is realized that the intermediate data also may be stored temporarily in the system memory 50 during the process. The flowchart will not be described in great detail, since the different steps have already been explained above.

In step 500, the process samples the output signal from the light sensor arrangement. In step 502, the sampled data is processed for calculation of projection values g(φ, s). In step 504, the process reads the interpolation function IF from the memory 50. The interpolation function IF could, e.g., be designed as the interpolation function in FIG. 14A. The process also reads “exclusion data” from the memory 50, or obtains this data directly from a dedicated process. The exclusion data identifies any faulty detection lines that should be excluded in the reconstruction process. The process modifies the interpolation function IF based on the exclusion data, resulting in an updated interpolation function IF′ which may be stored in the memory 50 for use as interpolation function during subsequent iterations. Based on the updated interpolation function IF′, and the projection values g(φ, s), step 504 generates new projection values (“interpolation values”, i) at given interpolation points. Step 504 results in a matched sinogram g′(φ, s), which contains the interpolation values, as possibly part of the original projection values in g(φ, s). In step 506, the process applies a 1D FFT on each column of data in the matched sinogram g′(φ, s). The result of step 506 is frequency data F(u, v) in the form of data points matched to a pseudo-polar grid in the Fourier domain. In step 508, the process reads “subarea data” from the memory 50, or obtains this data directly from a dedicated process. The subarea data indicates the parts of the attenuation field/touch surface to be reconstructed. Based on the subarea data, step 510 operates an 2D inverse FFT on the frequency data F(u, v), to reconstruct the attenuation field α(x, y), which is output, stored in memory 50, or processed further. Following step 508, the process returns to step 500.

It should be noted the above-described technique of updating the reconstruction function is applicable to all interpolation functions described herein, including those described in Chapters 5.2 and 5.3 below.

### 5.2 Re-Calculation by Fourier Transformation

In tomography theory, it is generally assumed that g(φ, s) is bandwidth limited. Thereby, it is possible to use Fourier transformation algorithms to perform the re-calculation step (42 in FIG. 4A) so as to form the above-mentioned updated set of sampling points.

In the following, a brief example is given on the use of an NED NUFFT algorithm in a re-calculation step. The theory behind the NED NUFFT algorithm is further described in the article “Non-Equispaced Fast Fourier Transforms with Applications to Tomography” by K Fourmont, published in “Journal of Fourier Analysis and Applications”, Volume 9, Number 5, pages 431-450 (2003), which is incorporated herein by this reference.

The example involves two FFT operations on the original set of projection values in the sinogram g(φ, s). First, a 2D NED NUFFT algorithm is operated on the sinogram:

$$\hat{g} ( ϑ , σ ) {←}^{{ℱ}_{2}} g ( {ϕ}_{k} , {s}_{k} ) ,$$

whereby the Fourier transform of the sinogram is computed. As noted above, the NED NUFFT algorithm is designed to process irregularly sampled data, and the resulting Fourier coefficients (θ, σ) will be arranged in a Cartesian grid. Then, a 2D inverse NER NUFFT algorithm is operated on the Fourier coefficients to get an updated set of projection values arranged in columns with adequate inter-column and intra-column spacing in the φ-s-plane:

$$g ( ϕ , s ) {←}^{{ℱ}_{2}^{- 1}} \hat{g} ( ϑ , σ ) .$$

A 2D inverse NER NUFFT algorithm may be used since the input data ĝ(θ, σ) is arranged on a Cartesian grid whilst the output data g(φ, s) is to be arranged with varying intra-column and/or inter-column spacing.

In this example, it may be advantageous for the c·N-periodicity of the re-calculation step to be for φ=2π. This may be achieved by mirroring the sinogram values before applying the NED NUFFT algorithm: g(φ, s)=g(φ−π, −s) for π≦φ<2π. However, this extension of the sinogram is not strictly necessary. In a variant, it is merely ensured that the wrapping behavior of the c·N-periodicity is consistent with the mirroring of the sinogram values.

It is to be understood that the re-calculation is not limited to the use of the NED/NER NUFFT algorithm, but can be achieved by applying any other suitable Fourier transformation algorithm designed for irregularly sampled data.

### 5.3 Re-Calculation by Weighted Average Interpolation

The interpolation in the re-calculation step (42 in FIG. 4A) may be based on a weighted average algorithm. Like Delaunay triangulation, the weighted average algorithm involves applying a linear operator on the measured projection values, with the coefficients in the linear operator being given by the known locations of the original sampling points and the interpolation points in the sample space.

One benefit of weighted average interpolation is that the computation of the coefficients may be simple to implement, e.g. compared to Delaunay triangulation. Another benefit is the possibility of doing on-the-fly computation of the coefficients in the linear operator (instead of using pre-computed coefficients) if available memory is limited, e.g. when the processing unit (14 in FIG. 2A) is implemented as an FPGA.

These benefits will be further illustrated by way of an example, in which a weighted average algorithm is used for on-the-fly interpolation of original projection values g(φₖ, sₖ) into a matched sinogram g′(φ′ᵢ, s′ⱼ), in three steps S1-S3. Reverting to FIG. 14B, the original projection values correspond to the sampling points (filled circles), and the matched sinogram corresponds to the interpolation points (stars and open circles). In the following example, the weight function is represented as F_{WF}:
S1. Initialize an accumulator sinogram, acc(φ′ᵢ, s′ⱼ), and a weight sinogram, w(φ′ᵢ, s′ⱼ), by setting them to zero.
S2. For each sampling point (φₖ, sₖ), execute the following sequence of sub-steps i.-iii. for all interpolation points (φ′ᵢ, s′ⱼ):
   i. ω=F_{WF}(Δφ, Δs)=F_{WF}(φₖ−φ′ᵢ, sₖ−s′ⱼ)
   ii. acc(φ′ᵢ, s′ⱼ)=acc(φ′ᵢ, s′ⱼ)+ω·g(φₖ, sₖ)
   iii. w(φ′ᵢ, s′ⱼ)=w(φ′ᵢ, s′ⱼ)+ω
S3. For each interpolation point (φ′ᵢ, s′ⱼ), compute the matched sinogram:
   If w(φ′ᵢ, s′ⱼ)>0, then set g′(φ′ᵢ, s′ⱼ)=acc(φ′ᵢ, s′ⱼ)/w(φ′ᵢ, s′ⱼ), otherwise set g′(φ′ᵢ, s′ⱼ)=0

There are numerous weight functions F_{WF} that may be used in this and other examples. One characteristic of a suitable weight function F_{WF} is that it decreases as |Δφ|, |Δs| increase. The constants in the weight function F_{WF} may be chosen such that each projection value g(φₖ, sₖ) contributes to only one or a few interpolation points (φ′ᵢ, s′ⱼ). This makes it possible to speed up the interpolation significantly since step S2 is reduced to an accumulation in the vicinity of the respective sampling point (φₖ, sₖ). In one example, the sub-steps i.-iii. are only executed for the 3×3 interpolation points (φ′ᵢ, s′ⱼ) that are closest to each sampling point (φₖ, sₖ) in the sample space, e.g. the 3 closest interpolation points in the 3 closest columns.

A few non-limiting examples of weight functions include: F_{WF}(Δφ, Δs)=e^{-(Δφ}^{²}^{/2σ}^{_{φ}}^{²}^{+Δs}^{²}^{/2σ}^{ₛ}^{²⁾}, and F_{WF}(Δφ, Δs)=1/(1+α₁·Δφ²+α₂·Δs²), where σ_{φ}, σₛ, α₁, α₂ are constants.

Generally, the interpolation by weighted average may be seen to involve, for each interpolation point, a step of calculating a weighted contribution to the value of the interpolation point from at least a subset of the sampling points (e.g. implemented by S2: ii.), and a step of aggregating the weighted contributions (e.g. implemented by S2: iii. and S3), wherein each weighted contribution is calculated as a function of the projection value of the sampling point and a distance in the sample space between the interpolation point and the sampling point.

### 6. ALTERNATIVE RECONSTRUCTION TECHNIQUES

It is to be understood that the reference to Fourier-based reconstruction techniques herein is merely given as an example of a technique for reconstructing the attenuation field based on the updated set of projection values that results from the re-calculation. There are many other known techniques that can be used for reconstruction, such as for instance ART, SIRT, SART and Filtered Back Projection (FBP). More information about these and other algorithms can be found, e.g., in the above-mentioned books “The Mathematics of Computerized Tomography” by Natterer, and “Principles of Computerized Tomographic Imaging” by Kak and Slaney.

It can also be noted that in certain implementations, it may be advantageous to perform a low-pass filtering of the updated set of projection values that results from the re-calculation, before applying the reconstruction technique.

### 7. CONCLUDING REMARKS

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the reconstructed attenuation field may be subjected to post-processing before the touch data extraction (46 in FIG. 4A). Such post-processing may involve different types of filtering, for noise removal and/or image enhancement.

Furthermore, it is to be understood that the inventive concept is applicable to any touch-sensitive apparatus that defines a fixed set of detection lines and operates by processing measured projection values for the detection lines according to any tomographic reconstruction algorithm that is capable/defined/optimized for operating on data samples matched to a pseudo-polar grid in the Fourier domain, where the fixed set of detection lines are mismatched to such a pseudo-polar grid.

It should also be emphasized that all the above embodiments, examples, variants and alternatives given with respect to interpolation and removal of detection lines are generally applicable to any type of emitter-sensor arrangement.

The person skilled in the art realizes that there are other ways of generating projection values based on the output signal. For example, each individual projection signal included in the output signal may be subjected to a high-pass filtering in the time domain, whereby the thus-filtered projection signals represent background-compensated energy and can be sampled for generation of projection values.

Furthermore, all the above embodiments, examples, variants and alternatives given with respect to an FTIR system are equally applicable to a touch-sensitive apparatus that operates by transmission of other energy than light. In one example, the touch surface may be implemented as an electrically conductive panel, the emitters and sensors may be electrodes that couple electric currents into and out of the panel, and the output signal may be indicative of the resistance/impedance of the panel on the individual detection lines. In another example, the touch surface may include a material acting as a dielectric, the emitters and sensors may be electrodes, and the output signal may be indicative of the capacitance of the panel on the individual detection lines. In yet another example, the touch surface may include a material acting as a vibration conducting medium, the emitters may be vibration generators (e.g. acoustic or piezoelectric transducers), and the sensors may be vibration sensors (e.g. acoustic or piezoelectric sensors).

Still further, the inventive concept may be applied to improve tomographic reconstruction in any field of technology, such as radiology, archaeology, biology, geophysics, oceanography, materials science, astrophysics, etc, whenever the detection lines are mismatched to a standard geometry that forms the basis for the tomographic reconstruction algorithm. Thus, the inventive concept could be generally defined as a method for image reconstruction based on an output signal from a tomograph, the tomograph comprising a plurality of peripheral entry points and a plurality of peripheral withdrawal points, which between them define actual detection lines that extend across a measurement space to propagate energy signals from the entry points to the withdrawal points, at least one signal generator coupled to the entry points to generate the energy signals, and at least one signal detector coupled to the withdrawal points to generate the output signal, the method comprising: processing the output signal to generate a set of data samples, wherein the data samples are indicative of detected energy for at least a subset of the actual detection lines; processing the set of data samples to generate a set of matched samples, wherein the matched samples are indicative of estimated detected energy for fictitious detection lines that extend across in the measurement space in parallel groups at a plurality of different angles, wherein the individual spacing between said fictitious detection lines in each group and the individual difference in angle between said groups, are selected such that the set of matched samples transforms to Fourier coefficients arranged as data points on a pseudo-polar grid in a Fourier domain; and processing the set of matched samples by tomographic reconstruction to generate a distribution of an energy-related parameter within at least part of the measurement space.

1.-23. (canceled)

24. A method of enabling touch determination based on an output signal from a touch-sensitive apparatus, the touch-sensitive apparatus comprising a panel configured to conduct signals from a plurality of peripheral incoupling points to a plurality of peripheral outcoupling points, thereby defining actual detection lines that extend across a surface portion of the panel between pairs of incoupling and outcoupling points, at least one signal generator coupled to the incoupling points to generate the signals, and at least one signal detector coupled to the outcoupling points to generate the output signal, the method comprising:
processing the output signal to generate a set of data samples, wherein the data samples are indicative of detected energy for at least a subset of the actual detection lines;
processing the set of data samples to generate a set of matched samples, wherein the matched samples are indicative of estimated detected energy for fictitious detection lines that extend across the surface portion in parallel groups at a plurality of different angles, wherein the individual spacing between said fictitious detection lines in each group and the individual difference in angle between said groups are selected such that the set of matched samples transforms to Fourier coefficients arranged as data points on a pseudo-polar grid in a Fourier domain; and
processing at least the set of matched samples by tomographic reconstruction to generate a two-dimensional distribution of an interaction parameter within at least part of the surface portion.

25. The method of claim 24, wherein the step of processing the set of matched samples comprises: operating a one-dimensional Fourier transformation function on separate subsets of the matched samples, each subset corresponding to one of said parallel groups, so as to generate complex values for the data points on the pseudo-polar grid, and processing the complex values to generate the two-dimensional distribution, wherein processing the complex values comprises operating an inverse Fourier transformation algorithm on the complex values.

26. The method of claim 24, wherein the step of processing the output signal comprises: generating the data samples in a two-dimensional sample space, wherein each data sample is representative of an actual detection line and is defined by a signal value and two dimension values that define the location of the actual detection line on the surface portion.

27. The method of claim 26, wherein the two dimension values comprise a rotation angle of the detection line in the plane of the panel, and a distance of the detection line in the plane of the panel from a predetermined origin.

28. The method of claim 26, wherein the step of processing the set of data samples comprises: generating estimated signal values of the matched samples at predetermined locations in the two-dimensional sample space, wherein the predetermined locations correspond to the fictitious detection lines.

29. The method of claim 28, wherein the estimated signal values are generated by interpolation based on the signal values of the data samples.

30. The method of claim 29, wherein each estimated signal value is generated by interpolation of the signal values of neighboring data samples in the two-dimensional sample space.

31. The method of claim 29, wherein the step of processing the set of data samples further comprises: obtaining a predetermined two-dimensional interpolation function with nodes corresponding to the set of data samples, and calculating the estimated signal values according to the interpolation function and based on the signal values of the data samples.

32. The method of claim 31, further comprising: receiving exclusion data identifying one or more data samples to be excluded, wherein the step of processing the data samples comprises: identifying the node corresponding to each data sample to be excluded, re-designing the predetermined interpolation function without the thus-identified node, and calculating the estimated signal values according to the re-designed interpolation function and based on the signal values of the data samples in the nodes of the re-designed interpolation function.

33. The method of claim 28, wherein the step of generating estimated signal values comprises, for each matched sample: calculating a weighted contribution to the matched sample from each data sample in at least a subset of the data samples, and aggregating the weighted contributions, wherein each weighted contribution is calculated as a function of the signal value of the data sample and a distance in the sample space between the matched sample and the data sample.

34. The method of claim 24, wherein the step of processing the set of data samples comprises: operating a two-dimensional Fourier transformation algorithm designed for irregularly sampled data on the set of data samples to generate first Fourier coefficients arranged in a Cartesian grid, and generating the estimated signal values by operating an inverse Fourier transformation algorithm on the first Fourier coefficients to generate the set of matched samples.

35. The method of claim 24, wherein the interaction parameter is representative of one of attenuation and transmission.

36. The method of claim 24, wherein the two-dimensional distribution comprises values of the interaction parameter arranged in a Cartesian grid on the surface portion.

37. The method of claim 24, wherein the pseudo-polar grid consists of concentrically aligned polygons, wherein each of said polygons is a convex polygon with pair-wise parallel line segments.

38. The method of claim 37, wherein each of said polygons consists of 4, 8 or 12 line segments.

39. The method of claim 37, wherein all parallel line segments among said polygons contain an equal number of equispaced data points.

40. The method of claim 24, wherein said signals comprise one of electrical energy, light, magnetic energy, sonic energy and vibration energy.

41. The method of claim 24, wherein the panel defines a touch surface and an opposite surface, wherein said at least one signal generator is arranged to provide light inside the panel, such that the light propagates from the incoupling points by internal reflection between the touch surface and the opposite surface to the outcoupling points for detection by said at least one signal detector, and wherein the touch-sensitive apparatus is configured such that the propagating light is locally attenuated by one or more objects touching the touch surface.

42. A device for enabling touch determination based on an output signal of a touch-sensitive apparatus, said touch-sensitive apparatus comprising a panel configured to conduct signals from a plurality of peripheral incoupling points to a plurality of peripheral outcoupling points, thereby defining actual detection lines that extend across a surface portion of the panel between pairs of incoupling and outcoupling points, means for generating the signals at the incoupling points, and means for generating the output signal based on detected signals at the outcoupling points, said device comprising:
means for receiving the output signal;
means for processing the output signal to generate a set of data samples, wherein the data samples are indicative of detected energy for at least a subset of the actual detection lines;
means for processing the set of data samples to generate a set of matched samples, wherein the matched samples are indicative of estimated detected energy for fictitious detection lines that extend across the surface portion in parallel groups at a plurality of different angles, wherein the individual spacing between said fictitious detection lines in each group and the individual difference in angle between said groups are selected such that the set of matched samples transforms to Fourier coefficients arranged as data points on a pseudo-polar grid in a Fourier domain; and
means for processing at least the set of matched samples by tomographic reconstruction to generate a two-dimensional distribution of an interaction parameter within at least part of the surface portion.

43. A touch-sensitive apparatus, comprising:
a panel configured to conduct signals from a plurality of peripheral incoupling points to a plurality of peripheral outcoupling points, thereby defining actual detection lines that extend across a surface portion of the panel between pairs of incoupling and outcoupling points;
at least one signal generator coupled to the incoupling points to generate the signals;
at least one signal detector coupled to the outcoupling points to generate an output signal; and
a signal processor connected to receive the output signal and configured to:
process the output signal to generate a set of data samples, wherein the data samples are indicative of detected energy for at least a subset of the actual detection lines,
process the set of data samples to generate a set of matched samples, wherein the matched samples are indicative of estimated detected energy for fictitious detection lines that extend across the surface portion in parallel groups at a plurality of different angles, wherein the individual spacing between said fictitious detection lines in each group and the individual difference in angle between said groups are selected such that the set of matched samples transforms to Fourier coefficients arranged as data points on a pseudo-polar grid in a Fourier domain, and
process at least the set of matched samples by tomographic reconstruction to generate a two-dimensional distribution of an interaction parameter within at least part of the surface portion.
